(19) United States
(12) Patent Application Publication
(10) Pub. No.: US 2026/0299896 A1
(43) Pub. Date: Oct. 1, 2026

(54) USER INTERFACE FOR CREATING A WORKFLOW FROM A NATURAL LANGUAGE PROMPT USING ARTIFICIAL INTELLIGENCE

(71) Applicant: Notion Labs, Inc., San Francisco, CA (US)

(72) Inventor: Simon Townsend-Last, New York, NY (US)

(21) Appl. No.: 19/194,735

(22) Filed: Apr. 30, 2025

Related U.S. Application Data
(60) Provisional application No. 63/779,490, filed on Mar. 28, 2025.

(51) Int. Cl. G06F 8/34; G06F 8/33; G06F 11/3668

(52) U.S. Cl. CPC G06F 8/34; G06F 8/33; G06F 11/3684

(57) ABSTRACT

The system obtains a natural language input describing a trigger and an action, where the trigger includes an indication of an input, the action includes an indication of an output, and the action is performed upon an occurrence of the trigger. The system analyzes the natural language input and, based on the analysis, creates a connection between the input and the output. Creating the connection between the input and the output includes creating and executing computer code without requiring the user to directly specify the computer code. The system determines whether the trigger has occurred and, upon determining it has, performs the action and provide a visualization indicating the output.

### CROSS-REFERENCE TO RELATED APPLICATIONS

This application claims the benefit of priority to U.S. Provisional Application 63/779,490, filed on Mar. 28, 2025, which is incorporated by reference herein in its entirety.

### BACKGROUND

A variety of repetitive tasks can be performed by various users in various contexts, and the creation of the specific instances of repetitive tasks can consume a significant portion of resources. These tasks include data entry into databases or spreadsheets and document management, which involves organizing, updating, and retrieving documents. Generating reports, which involves collecting data, analyzing the data, and presenting the findings in a structured format, can also consume a significant portion of resources. These repetitive tasks, while essential, can be resource-consuming even though they are duplicated from user to user.

### BRIEF DESCRIPTION OF THE DRAWINGS

Reference will now be made, by way of example, to the accompanying drawings, which show example embodiments of the present application and in which:

FIG. 1 is a block diagram of an example software platform.

FIG. 2 is a block diagram of an example transformer.

FIG. 3 is a block diagram illustrating a hierarchical organization of pages in a workspace.

FIG. 4 shows a system to create a workflow in a software platform from the outset based on natural language input.

FIG. 5 shows a hierarchy of components to use in creating and running tests.

FIG. 6 is a flowchart of a method to create a workflow from a natural language prompt using an artificial intelligence.

FIG. 7 is a flowchart of a method to create, using artificial intelligence, a test of a hierarchical software system.

FIG. 8 shows a system to create a workflow in a software platform from the outset based on existing workflows or workflow templates.

FIG. 9 shows a system to determine matching components.

FIG. 10 is a flowchart of a method to create a workflow in a software platform from the outset based on existing workflows or workflow templates.

FIG. 11 shows a system to customize an existing workflow using natural language prompts.

FIG. 12 shows an interface to customize an existing workflow.

FIG. 13 is a flowchart of a method to customize a workflow in a software platform using artificial intelligence.

FIG. 14 shows a user interface to invoke the system to build a workflow as described in this application.

FIG. 15 shows a user interface to create a workflow.

FIG. 16 shows execution of an initial step determined by the AI in FIG. 15.

FIG. 17 shows the user interface once the user selects the appropriate user interface element, in FIG. 16.

FIG. 18 shows user interface including the created components.

FIG. 19 shows a user interface element to repair the connection between an input and an output.

FIG. 20 shows the user interface enabling a user to select properties to include in the output.

FIG. 21 shows a visualization of the output.

FIG. 22 shows using natural language input to debug the output.

FIG. 23 shows results of the debugging steps expressed as natural language description.

FIG. 24 shows a visualization of the requested output.

FIG. 25 shows a view of the output created without prompting.

FIG. 26 shows results an action that the AI performed without prompting, and a change to the action.

FIG. 27 is a flowchart of a method to create a software application, e.g.

FIG. 28 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed system can create and customize a workflow using artificial intelligence from the outset or from existing or instantiated templates. The workflow can automate a variety of repetitive tasks. In addition, the disclosed system can create tests to verify that the resulting workflow operates correctly.

In one embodiment, the system obtains an indication to use an artificial intelligence to create a workflow within a software platform, where the workflow includes multiple components comprising a database, a trigger, and a function, where the trigger describes an event upon which occurrence the function is performed, and where the indication includes a first natural language input describing an output based on an input. Using the artificial intelligence, the system analyzes the first natural language input to create a natural language description of one or more components to include in the workflow. The system presents the one or more components to include in the workflow to a user and enables the user to modify the one or more components by providing a second natural language input describing a modification to the one or more components. The modification can be an iterative process. The system receives an indication from the user to create the one or more components and, based on the natural language description of the one or more components, generates a code that, when executed by a processor, creates an instance of the one or more components. For example, the code can include a database schema for a database or JavaScript for a function. The system creates a test associated with the workflow, where executing the test verifies whether the workflow is valid.

In another embodiment, the system obtains a workflow associated with a software platform, where the workflow includes multiple components comprising a database, a trigger, and a function. The function can make a call to a subfunction. The trigger describes an event upon which occurrence the function is performed. The system obtains a hierarchy of the multiple components associated with the workflow, where a root level of the hierarchy includes the workflow and where a child level of the hierarchy includes the database, the trigger, and/or the function. The system creates a test associated with the workflow, where executing the test verifies whether the workflow produces the output. The test includes a child level test and a root level test, where the child level test includes a first test to test the database, the second test to test the trigger, and/or a third test to test the function and where the root level test includes a fourth test to test the workflow. The system executes the test starting with the lowest level of the hierarchy, e.g., the child level test, and determines whether the child level test indicates that the child level of the hierarchy is valid. Upon determining that the child level test indicates that the child level of the hierarchy is valid, the system executes the root level test. The system determines whether the root level test indicates that the root level of the hierarchy is valid and, upon determining that the root level test of the hierarchy is valid, indicates that the workflow is valid.

In another embodiment, the system obtains an indication to use an artificial intelligence to create a workflow within a software platform, where the workflow includes a database, a view of the database, a connection, an automation, an artificial intelligence action, a setting, and a template metadata. The indication includes a natural language input describing an output based on an input. The system obtains existing components including an existing workflow, an existing database, an existing view of the database, an existing connection, an existing automation, an existing artificial intelligence action, an existing setting, and an existing template metadata. The system uses the artificial intelligence to analyze the natural language input and to determine needed components to produce the output. The needed components include a needed workflow to produce the output, a needed database to produce the output, a needed view of the database to produce the output, a needed connection to produce the output, a needed automation to produce the output, a needed artificial intelligence action to produce the output, a needed setting to produce the output, or a needed template metadata to produce the output. Among the existing components, the system determines matching components to the needed components, where the matching components include a matching workflow, a matching database, a matching view of the database, a matching connection, a matching automation, a matching artificial intelligence action, a matching setting, and a matching template metadata. The system creates the needed workflow to produce the output.

In another embodiment, the system obtains an indication to modify a workflow within a software platform, where the workflow includes components including a database, a view of the database, a connection, an automation, an artificial intelligence action, a setting, and a template metadata. The indication to modify the workflow includes a natural language input describing a modification to the workflow. The system uses the artificial intelligence to analyze the natural language input and to determine modification components to produce the modification. The modification can include addition, deletion, or a change to a component. The modification components include a modification workflow to produce the output, a modification database to produce the output, a modification view of the database to produce the output, a modification connection to produce the output, a modification automation to produce the output, a modification artificial intelligence action to produce the output, a modification setting to produce the output, or a modification template metadata to produce the output. The system creates one or more of the modification components by adding, deleting, or changing one or more components in the workflow.

In another embodiment, an artificial intelligence (AI) obtains a natural language input describing a trigger and an action, where the trigger includes an indication of an input, where the action includes an indication of an output, and where the action is performed upon an occurrence of the trigger. The AI analyzes the natural language input, and based on the analysis, creates a connection between the input and the output. Creating the connection between the input and the output includes creating and executing computer code without requiring the user to directly specify the computer code. The AI determines whether the trigger has occurred, and upon determining that it has, performs the action and provide a visualization indicating the output and indicating that the trigger has occurred.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested subpages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory, and existing blocks are modified. In native apps, the model caches all records that are accessed locally in an LRU (least recently used) cache on top of SQLite or IndexedDB, referred to as RecordCache. When records are changed on a native app, the model also updates the local copies in “RecordCache.” The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then, the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as “loadPageChunk”; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

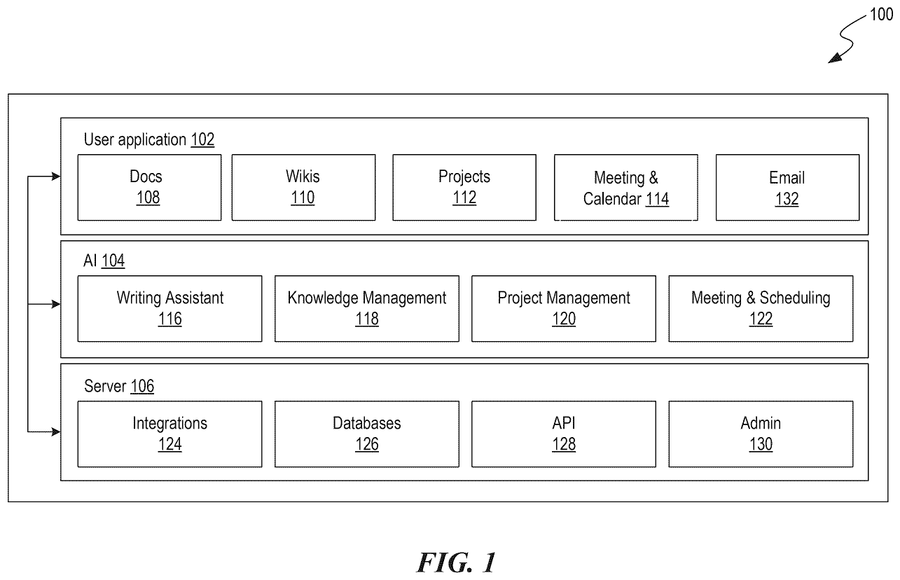

FIG. 1 is a block diagram of an example software platform 100. The software platform (“platform”) 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or subpages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a subheading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view, such as artificial intelligence-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100 or an embedding of a block in the document. In another example, a wiki can link to a meeting within the calendar.

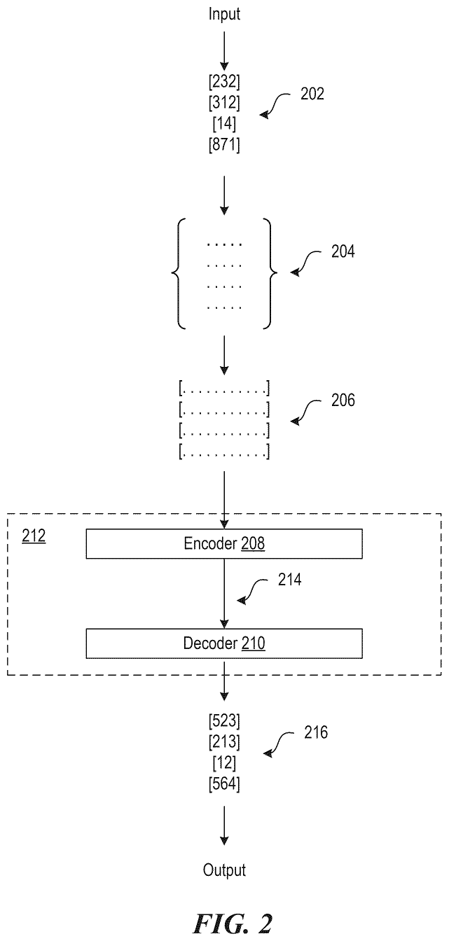

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto-filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”), and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks, and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) as compared, for example, with models with fewer layers. In the present disclosure, the term “ML-based model” or, more simply, “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online web pages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger dataset and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as “training.” Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that while the term “language model” has been commonly used to refer to an ML-based language model, there could exist non-ML language models. In the present disclosure, the term “language model” can refer to an ML-based language model (e.g., a language model that is implemented using a neural network or other ML architecture) unless stated otherwise. For example, unless stated otherwise, the “language model” encompasses LLMs (large language models).

A language model can use a neural network (typically a DNN) to perform natural language processing (NLP) tasks. A language model can be trained to model how words relate to each other in a textual sequence based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on input formats other than natural language input. For example, the input can include objects, images, audio content, video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture) unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts, such as data security. Tokenization, in the context of language models and NLP, refers to the process of parsing textual input (e.g., a character, a word, a phrase, a sentence, a paragraph) into a sequence of shorter segments that are converted to numerical representations referred to as “tokens” (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a “latent space” or “feature space.”

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user, and the output can include a high-level summary of the meeting notes. In other examples, the input provided to the transformer includes a question or a request to generate text. The output can include a response to the question, text associated with the request, or a list of ideas associated with the request. For example, the input can include the question, “What is the weather like in San Francisco?” and the output can include a description of the weather in San Francisco. As another example, the input can include a request to brainstorm names for a flower shop, and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a “prompt,” which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a “zero-shot prompt.”

### Hierarchical Organizational Blocks in a Workspace

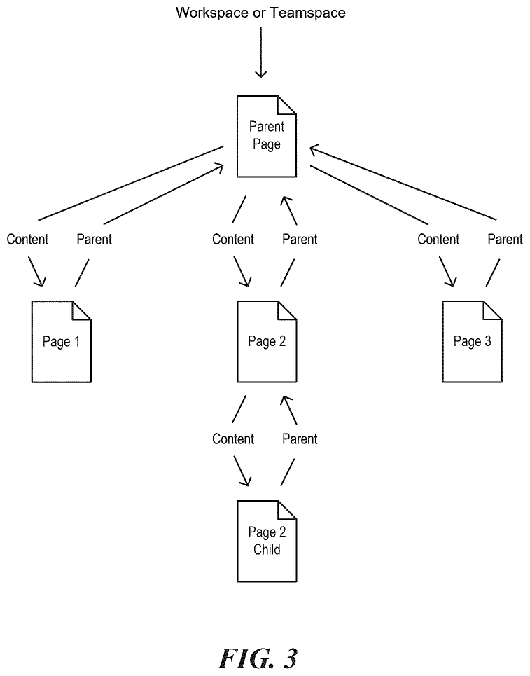

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children, while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the Internet, while “Page 2” is only shared internally with the users associated with the workspace. As another example, “Page 2 Child” can be shared only with an individual user, while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Creating and Testing a Workflow from a Natural Language Prompt from the Outset Using Artificial Intelligence

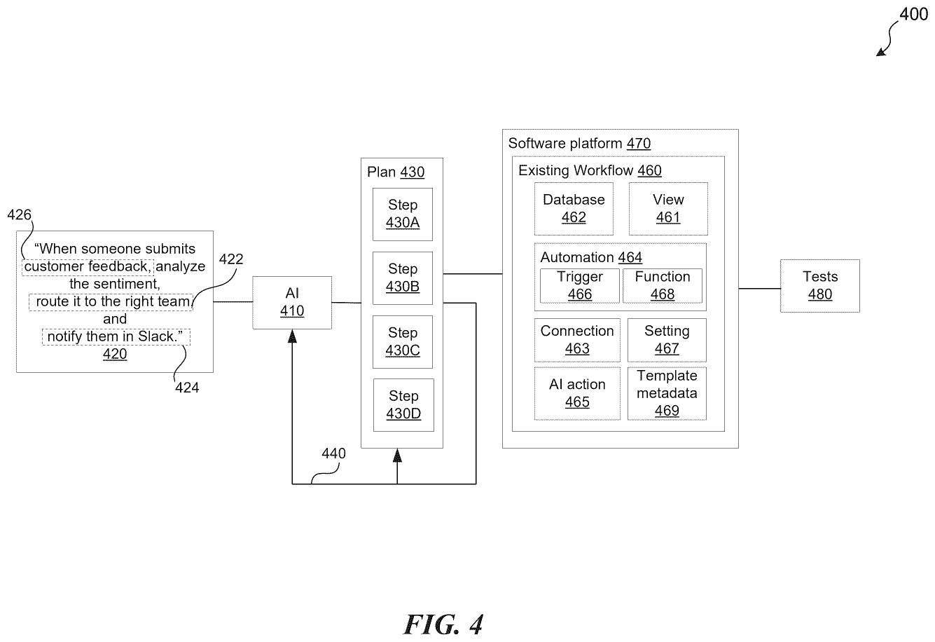

FIG. 4 shows a system to create a workflow in a software platform from the outset based on natural language input. The system 400 includes an artificial intelligence (AI) 410 that can receive a natural language input 420 describing an output 422, 424 based on an input 426. For example, the natural language input 420 can state, “When someone submits customer feedback, analyze the sentiment, route it to the right team, and notify them in Slack.” In the above example, the outputs can be “route the customer feedback to the right team” 422 and “Slack notification” 424, while the inputs can be “customer feedback” 426.

The AI 410 can create a plan 430 that includes multiple steps 430A, 430B, 430C, 430D. Each step 430A, 430B, 430C, 430D can be a natural language description, e.g., English language description, explaining a function of the step. Based on the natural language input 420, the step 430A can include “invoke artificial intelligence to determine the sentiment,” the step 430B can be “based on the sentiment, determine the right team to which to send the customer feedback,” the step 430C can be “send the customer feedback to the determined team,” and the step 430D can be “notify the determined team in Slack.”

The system 400 can present the natural language description of each step 430A, 430B, 430C, 430D to a user and allow the user in step 440 to iteratively modify each step 430A, 430B, 430C, 430D by, for example, editing the natural language description of each step or through a conversational interface with the AI 410. For example, the user can instruct the AI 410 to “modify the last step to also notify the submitter that the customer feedback has been reported to team X.” Upon receiving the user instruction, the AI 410 can make the modification to step 430D.

After receiving an approval from the user of the steps 430A, 430B, 430C, 430D, the system 400 can build a workflow 460 associated with a software platform for 470, where the workflow receives the specified inputs and produces the specified output. The workflow 460 can include multiple components such as a database 462, an automation 464, which can include a trigger 466 and an action, e.g., a function, 468. Additionally, the workflow 460 can include additional components such as a view 461 of the database, a connection 463, an artificial intelligence action 465, a setting 467, and a template metadata 469. The workflow 460 can also be a software application because the workflow can include computer code to perform an action, e.g. function 468, upon the occurrence of the trigger.

The database 462 can be a source database parented by the workflow 460 or can be linked to other databases that are not parented by the workflow. The connections 463 can be links between the database and a software platform external to the software platform for 470. Some examples of links to external software platforms can include Slack threads, GitHub pull requests, and web searches. The database 462 can be exposed in a navigation user interface of the workflow or can be hidden.

The view 461 can provide primary and optional interfaces to interact with the workflow 460. The view 461 can have the following types:
Page
Table
List
Board
Gallery
Calendar
Timeline
Chart
Form

In addition, the view 461 can have more complex types:
Home/Dashboard view, which provides a grid arrangement of multiple views.
AI chat, which provides past chats and allows initiation of new chats.
Activity feed, which provides a unified feed of activities and is filterable.

### Custom View, Which Can Be Ai-generated.

The automation 464 can include the trigger 466 and the function 468. The trigger 466 can describe a specific event to watch for, e.g., “when a row is added to this database” or “when someone posts in this Slack channel.” When the specific event occurs, the trigger 466 can fire, and the workflow 460 runs actions 468. The actions 468 can include JavaScript functions that can interact with the software platform for 470, external tools, AI 410, and/or other large language models. The workflow 460 can connect to the existing software platform for 470 databases or create new databases purpose-built for the automation 464.

The action 468 can call APIs internal to the software platform for 470 or can call APIs external to the software platform, such as Google or Salesforce APIs. The action 468 can run code. The system 400 can present the code to the user and enable the user to edit the raw code, or the system 400 can use AI 410 to generate a natural language description of the code and allow the user to edit the code through natural language conversation with the AI 410.

The artificial intelligence action 465 can include a workflow edit history with a log of a history of chat-based modifications. The setting 467 and the template metadata 469 can configure the template versions of the workflow in the workflow components to create the specific instance of the workflow 460 and the workflow components 461-469.

After building the workflow 460 with the needed components 461-469, the system 400 can create tests 480 to run on the workflow 460 to verify that the workflow produces the desired output 422, 424. Once the workflow 460 is verified, the system 400 can deploy the workflow into production. After running the tests 480, the system 400 can store a log of the test runs and can provide the logs to the user. The user can monitor the test runs, give feedback, and make modifications to the workflow 460.

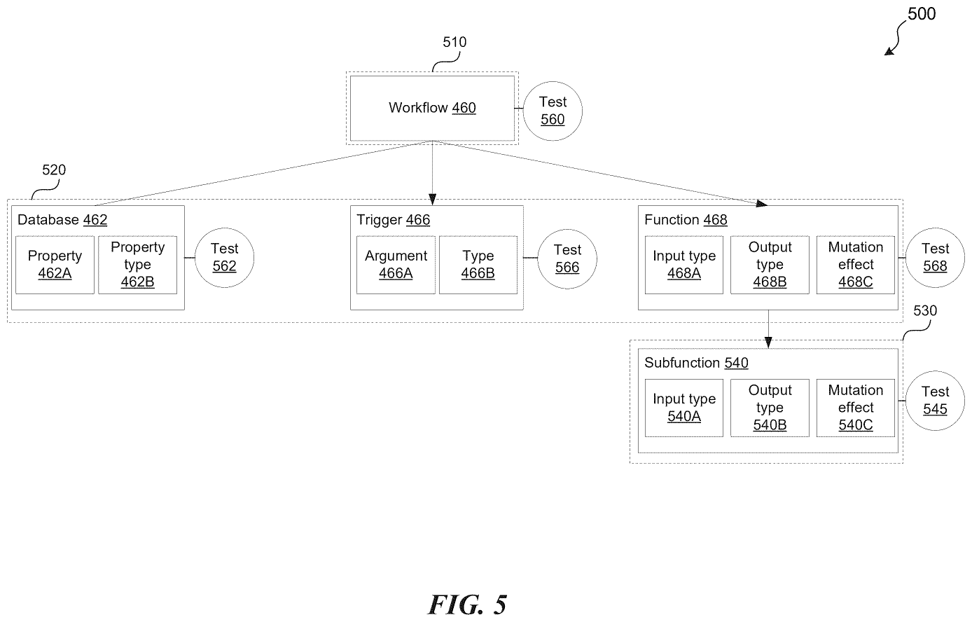

FIG. 5 shows a hierarchy of components to use in creating and running tests. The hierarchy 500 can include multiple levels starting with the root level 510, a first child level 520, and the second child level 530. The hierarchy 500 can be two or more levels deep.

The root level 510 can include an overall container, such as the workflow 460. The first child level 520 can include a database 462, a trigger 466, and a function 468. The second child level 530 can include a subfunction 540, which is called by the function 468.

The container 460 and component 462, 466, 468 can have corresponding tests 560, 562, 566, 568. The system can run the tests starting with the lowest level, e.g., second child level 530, in the hierarchy 500. After the lowest level passes the test, the system continues to run tests at the next higher level, e.g., the first child level 520, until the next higher level passes the test, up until the root level 510 passes the test and is verified.

The database 462 can include a schema with a property 462A and the property type 462B. The test 562 for the database 462 can determine whether the database 462 is valid by determining whether the schema includes the valid property 462A and the valid property type 462B. If the schema includes the valid property 462A and the valid property type 462B, the test 562 can verify that the database 462 is valid.

The trigger 466 can include one or more arguments 466A and a type 466B. The test 566 for the trigger 466 can determine whether the trigger is valid by determining whether the trigger has a valid type 466B with valid arguments 466A. If so, the test for 566 can verify that the trigger 466 is valid.

The function 468 can include an input type 468A, an output type 468B, and an optional mutation effect 468C. The mutation effect 468C can include an action separate from the input and output of the function 468. For example, the mutation effect 468C can include posting a message to Slack or sending an email in addition to producing an output. The subfunction 540, called by the function 468, can include an input type 540A and output type 540B in an optional mutation effect 540C. The subfunction 540 can call its own subfunction, and the number of hierarchy levels of functions and some functions can be arbitrary. Each function 468 and subfunction 540 can have a corresponding test 568, 545.

The test 568, 545 can obtain or create an input to having the input type 468A, 540A, the expected output corresponding to the output type 468B, 540B, and the expected mutation effect 468C, 540C, if needed. The test 568, 545 can run the function 468 and/or the subfunction 540, obtain the outputs, and determine whether the outputs correspond to the expected outputs. Similarly, the test 568, 545 can obtain the mutation effects and determine whether they match the expected mutation effects. An artificial intelligence (AI) can determine whether the outputs and/or the mutation effects match the expected outputs and expected mutation effects, respectively. For example, the AI, e.g., AI 410 in FIG. 4, can be a large language model trained to produce a similarity score. If the similarity score is above a predetermined threshold, the AI can determine that the outputs and/or the mutation effects match the expected outputs and expected mutation effects.

The container 460 and component 462, 466, 468 may need to interface with a third-party software platform outside of the software platform for 470 in FIG. 4.

The system can perform the tests from the lowest level of the hierarchy, namely subfunction 540 in FIG. 5. If the tests 545 fails, the system can make a modification to the tests and rerun it until the test is a success. After the test 545 succeeds, the system can run tests for each higher level of the hierarchy in order, e.g., 520, only progressing to the next level in the hierarchy after all the previous levels in the hierarchy pass the test.

To test the root level 510 of the hierarchy 500, the system can determine whether the final output, including the outputs of the various tests 562, 566, 568, 545 and the mutation effects 468C, 540C, matches the outputs 422, 424 in FIG. 4, requested in the original natural language input 420. The AI can make the determination based on the natural language input 420 and the outputs of the various tests 562, 566, 568, 545 by producing a similarity score. If the similarity score is above a predetermined threshold, the AI can determine that the whole workflow 460 passed the test. If the AI determines that the workflow 460 did not pass the test, the system restarts the whole testing process with the lowest level 530 of the hierarchy 500 again.

If any of the tests 562, 566, 568, 545 fails, the system can determine whether the failure occurred in 1) the tests 562, 566, 568, 545; 2) container 460 or one of the components 462, 466, 468, 540; or 3) the system. Based on the categorization of failure into one of the above three categories, the system can obtain past similar failures and corresponding resolutions and provide the past similar failures and the resolution in a prompt to the AI, requesting a fix of the component that failed.

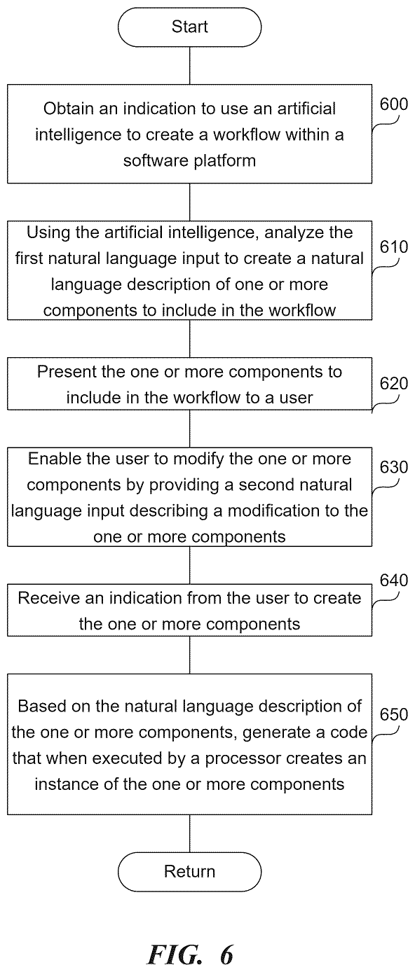

FIG. 6 is a flowchart of a method to create a workflow from a natural language prompt using an artificial intelligence. A hardware or software processor executing instructions describing this application can, in step 600, obtain an indication to use an artificial intelligence to create a workflow within a software platform, where the workflow includes multiple components comprising a database, a trigger, and/or a function. The trigger can describe an event upon which occurrence the function is performed. The indication can include a first natural language input describing an output based on an input.

In step 610, the processor, using the artificial intelligence, can analyze the first natural language input to create a natural language description of one or more components to include in the workflow.

In step 620, the processor can present the one or more components to include in the workflow to a user. In step 630, the processor can enable the user to modify the one or more components by providing a second natural language input describing a modification to the one or more components. This can be an iterative process. For example, the user can provide the second natural language input describing the modification, the processor can perform the modification, and if the user is not satisfied with the modification, the user can again provide a third natural language input to further modify the components.

In step 630, the processor can receive an indication from the user to create the one or more components. In step 640, based on the natural language description of the one or more components, the processor can generate a code that, when executed by a processor, creates an instance of the one or more components. For example, if the component is a database, the processor can, in step 640, generate a schema for the database. In another example, if the component is a function, the processor can, in step 640, generate JavaScript for the function.

The processor can obtain a hierarchy of the multiple components associated with the workflow, such as the hierarchy shown in FIG. 5. The root level of the hierarchy can include the workflow, while a child level of the hierarchy can include the database, the trigger, and/or the function. The function can call a subfunction, as described in this application. The processor can create a test associated with the workflow, where executing the test verifies whether the workflow produces the output and where the test includes a child level test and a root level test. The child level test can include a first test to test the database, the second test to test the trigger, and/or a third test to test the function. The root level test can include a fourth test to test the workflow. The processor can execute the test starting with the child level test and determine whether the child level test indicates that the child level of the hierarchy is valid. Upon determining that the child level test indicates that the child level of the hierarchy is valid, the processor can execute the root level test and determine whether the root level test indicates that the root level of the hierarchy is valid. Upon determining that the root level test of the hierarchy is valid, the processor can indicate that the workflow is valid.

Alternatively, upon determining that the child level test and/or the root level test indicates that the child level and/or the root level of the hierarchy is not valid, respectively, the processor can determine an element causing a failure by determining whether the failure is associated with the child level test, the software platform, the database, the trigger, and/or the function. Upon determining the element causing the failure, the processor can obtain information about prior failures and fixes associated with the element. The processor can provide the information about prior failures and fixes associated with the element to the artificial intelligence and a request to provide a fix to the failure. The processor can provide the information about prior failures and fixes in a prompt to the artificial intelligence or by training the artificial intelligence using the information as training data. The processor can obtain from the artificial intelligence the fix to the failure. The processor can implement the fix associated with the element causing the failure and execute at least a portion of the child level test associated with the fix.

The child level test can include a first test to test the database that can include a schema including a property type. The first test to test the database can determine whether the property type is valid.

The child level test can include a second test to test the trigger that can include a trigger type and a trigger argument. The second test to test the trigger can determine whether the trigger type and the trigger argument are valid.

The child level test can include a third test to test the function that can include an input type, an output type, and/or a mutation effect. The third test can create an input, unexpected output, and/or an expected mutation effect, run the function using the input, and obtain an output from running the function using the input and/or the mutation effect from running the function using the input. Finally, the third test can determine whether the output and/or the mutation effect from running the function using the input corresponds to the expected output and/or the expected mutation effect. To make the determination, the third test can invoke artificial intelligence that can determine a similarity score between the output and/or the mutation effect and the output and/or the mutation effect.

The processor can determine that the first natural language input indicates a use of data from a system external to the software platform, such as Gmail or Salesforce. The processor can create the test associated with the workflow by simulating the data from the system external to the software platform without placing a call to the system external to the software platform.

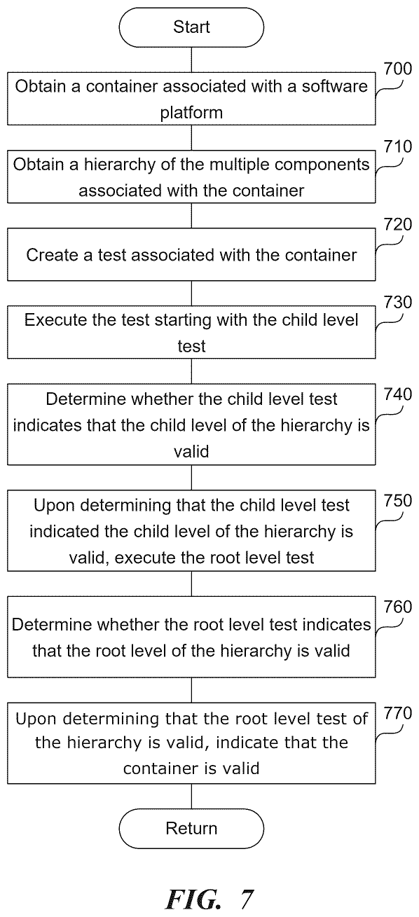

FIG. 7 is a flowchart of a method to create, using artificial intelligence, a test of a hierarchical software system. A hardware or software processor executing instructions described in this application can, in step 700, obtain a container associated with a software platform, where the container includes multiple components comprising a first component, second component, and/or third component. The container can be the workflow described in this application, while the first component can be a database, the second component can be a trigger, and the third component can be a function. The third component can have a fourth component, e.g., subfunction.

In step 710, the processor can obtain a hierarchy of the multiple components associated with the container, where a root level of the hierarchy includes the container and where a child level of the hierarchy includes the first component, the second component, and/or the third component.

In step 720, the processor can create a test associated with the container. Executing the test can verify whether the container is valid. The test can include a child level test and a root level test. The child level test can include a first test to test the first component, a second test to test the second component, and/or a third test to test the third component. The root level test can include a fourth test to test the container.

In step 730, the processor can execute the test starting with the child level test. In step 740, the processor can determine whether the child level test indicates that the child level of the hierarchy is valid. In step 750, upon determining that the child level test indicates that the child level of the hierarchy is valid, the processor can execute the root level test.

In step 760, the processor can determine whether the root level test indicates that the root level of the hierarchy is valid. In step 770, upon determining that the root level test of the hierarchy is valid, the processor can indicate that the container is valid.

The processor can obtain the hierarchy of the multiple components associated with the container, where the root level of the hierarchy includes the container, where the child level of the hierarchy includes the first component, the second component, and/or the third component, and where a second child level of the hierarchy includes a fourth component associated with the third component. The fourth component can be a subfunction. The processor can create the test associated with the container, where a second child level test includes a fifth test to the fourth component. The processor can execute the test starting with the second child level test. The processor can determine whether the second child level test indicates that the second child level of the hierarchy is valid. Upon determining that the second child level test indicates the second child level of the hierarchy is valid, the processor can execute the child level test.

Upon determining that the child level test indicates that the child level of the hierarchy is not valid, the processor can determine an element causing a failure by determining whether the failure is associated with the child level test, the software platform, the container, the first component, the second component, and/or the third component. Upon determining the element causing the failure, the processor can obtain information about prior failures and fixes associated with the element. The processor can provide the information about prior failures and fixes associated with the element to the artificial intelligence and a request to provide a fix to the failure. The processor can obtain from the artificial intelligence the fix to the failure. The processor can implement the fix associated with the element causing the failure. The processor can execute at least a portion of the child level test associated with the fix.

The processor can create the test including a child level test and a root level test, where the child level test includes a first test to test the first component, where the first test to test the first component includes a schema including a property type, and where the first test to test the first component determines whether the property type is valid.

The processor can create the test including a child level test and a root level test, where the child level test includes a second test to test the second component, where the second test to test the second component includes a second component type and a second component argument, and where the second test to test the second component determines whether the second component type and the second component argument is valid.

The processor can create the test including a child level test and a root level test, where the child level test includes a third test to test the third component, where the third test to test the third component includes an input type, an output type, and/or a mutation effect.

The processor can determine that the test indicates a use of data from a system external to the software platform. The processor can create the test associated with the container by simulating the data from the system external to the software platform without placing a call to the system external to the software platform.

### Creating a Workflow in a Software Platform Based on Existing Workflows or Workflow Templates Using Artificial Intelligence

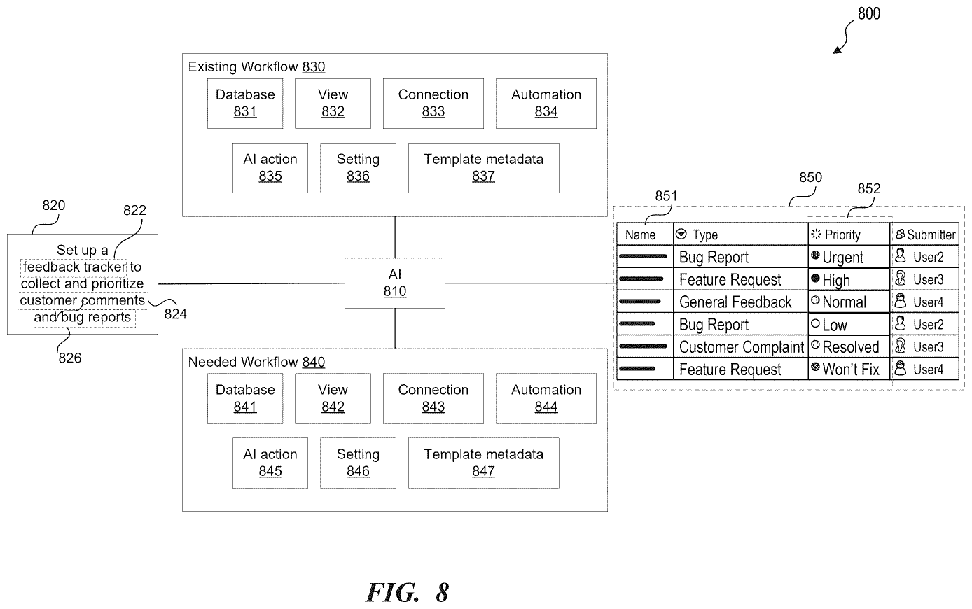

FIG. 8 shows a system to create a workflow in a software platform from the outset based on existing workflows or workflow templates. The system 800 can obtain an indication 820 to use an artificial intelligence 810 to create a workflow within a software platform, where the workflow can include a database, a view of the database, a connection, an automation, an artificial intelligence action, a setting, and a template metadata.

The indication 820 can include a natural language input describing an output 822 based on an input 824, 826. For example, the indication 820 can state, “Set up a feedback tracker to collect and prioritize customer comments and bug reports.” In this case, the output 822 is a database tracking feedback, and the input 824, 826 is “customer comments” and “bug reports.”

The AI 810 can obtain existing components such as existing templates or existing instantiated templates. Existing components can include an existing workflow 830, an existing database 831, an existing view 832 of the database, an existing connection 833, an existing automation 834, an existing artificial intelligence action 835, an existing setting 836, and an existing template metadata 837. The existing components 830-837 can be existing templates, instantiated templates, and/or a mix of the two.

The AI 810 can analyze the natural language input to determine needed components to produce the output 822. The needed components can include a needed workflow 840 to produce the output, a needed database 841 to produce the output 822, a needed view 842 of the database to produce the output, a needed connection 843 to produce the output, a needed automation 844 to produce the output, a needed artificial intelligence action 845 to produce the output, a needed setting 846 to produce the output, or a needed template metadata 847 to produce the output.

For example, the needed connection 843 can be a connection between the databases existing within the software platform 470 in FIG. 4 or a connection to external software platforms such as a Salesforce platform.

Among the existing components, the AI 810 can determine matching components to the needed components, where the matching components include a matching workflow, a matching database, a matching view of the database, a matching connection, a matching automation, a matching artificial intelligence action, a matching setting, and a matching template metadata. For example, based on the indication 820, the AI 810 can retrieve multiple existing databases but can determine that the matching database is an existing database that tracks feedback and bug reports and prioritizes those tasks.

Finally, the AI 810 can create the workflow 850 to produce the output. In the example in FIG. 8, the workflow 850 includes a database 851 and a view 852 of the database. The view 852 of the database 851 prioritizes the customer comments and bug reports.

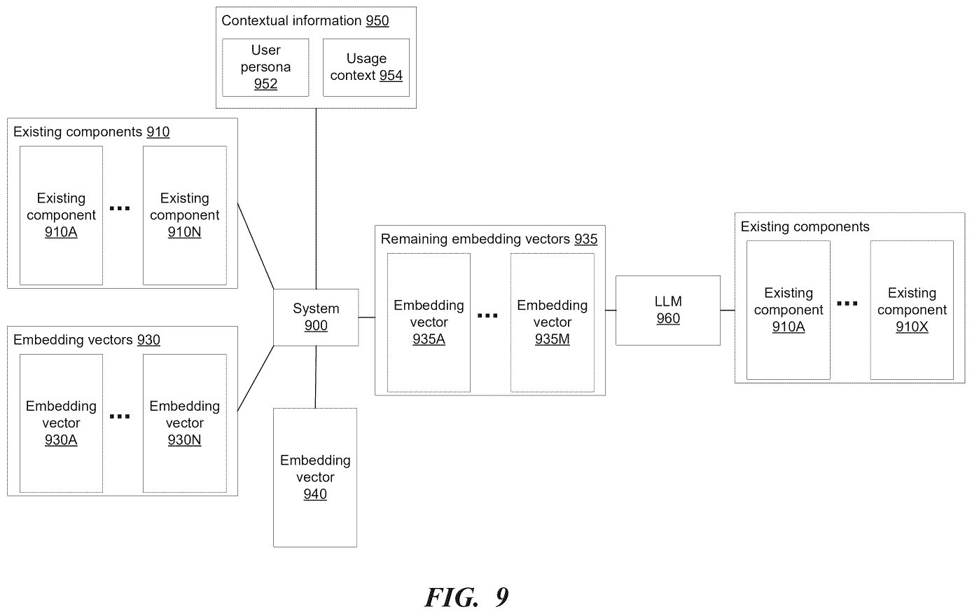

FIG. 9 shows a system to determine matching components. The system 900 can obtain multiple existing components 910 whose number can exceed tens of thousands of components. To determine the matching components 920, the system 900 can obtain embedding vectors 930, where each embedding vector 930A-930N represents an existing component 910A-910N.

An embedding vector 930A-930N is a numerical representation of data, such as words or images, that captures their meanings and relationships in a way that machine learning models can understand and process. These vectors are numerical vectors in a multidimensional space, where each dimension represents a specific feature of the data. For example, in the context of natural language processing, embedding vectors can represent words in a way that captures their semantic relationships, such as similarity in meaning or context.

The system 900 can also obtain an embedding vector 940 of a needed component 840-847 in FIG. 8 and can determine multiple measures of similarity between the embedding vector 940 and the embedding vectors 930A-930N representing existing components. To determine the similarity, the system 900 can also consider contextual information 950 such as user persona 952 and usage context 954. User persona 952 can indicate whether the user is a designer, an engineer, a manager, etc. Usage context 954 can indicate whether the component includes or is a part of a workspace, a teamspace, or a connected tool.

For example, the system 900 can use the contextual information 950 to retrieve existing components 910 that have contextual information similar to the contextual information 950 of the needed component 840-847.

The system 900 can generate multiple similarity scores by measuring the similarity between embedding vectors 930A-930N and the embedding vector 940 using various metrics, each with its own advantages and applications. One common method is Euclidean distance, which measures the straight-line distance between two vectors in a multidimensional space. It is computed as the square root of the sum of the squares of the differences between the corresponding components of the vectors. Another popular metric is cosine similarity, which measures the cosine of the angle between two vectors, considering only their direction and not their magnitudes. The formula for cosine similarity is the dot product of the vectors divided by the product of their magnitudes. Additionally, dot product similarity, which is the cosine similarity multiplied by the lengths of both vectors, considers both the magnitudes and directions of the vectors. These metrics are used in various applications such as semantic search, recommendation systems, and anomaly detection, where determining the similarity between vectors is crucial.

The system 900 can rank embedding vectors 930A-930N based on the multiple similarity scores and select a predetermined number of top scores, e.g., top 100 scores, thus reducing the search space to approximately 100 remaining embedding vectors 935A-935M. The system 900 can use a large language model (LLM) 960 trained to produce a similarity score to generate a new set of similarity scores from the remaining embedding vectors 935A-935M. The system 900 can rank the remaining embedding vectors 935A-935M according to the new set of similarity scores. The system 900 can suggest using one or more of the predetermined number of top existing components 910A-910X, e.g., 10 existing components, corresponding to the top X similarity scores in the new set of similarity scores. The system can present the predetermined number of top existing components 910A-910X to the user, with the user making the final selection of which existing component to use.

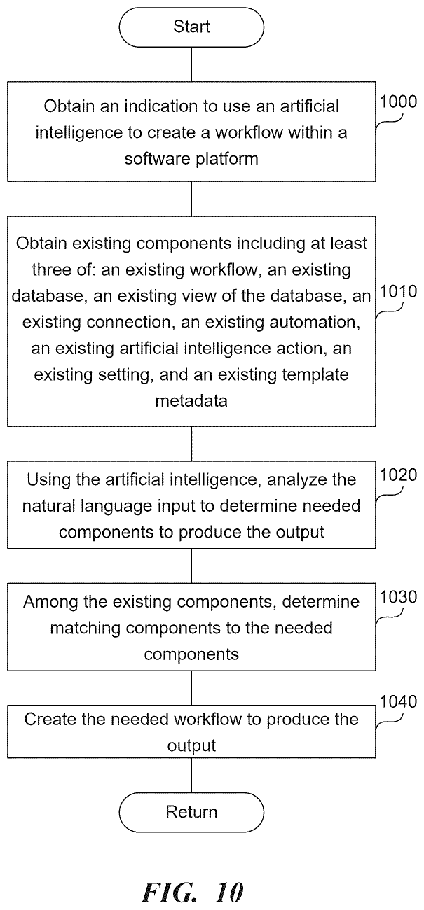

FIG. 10 is a flowchart of a method to create a workflow in a software platform from the outset based on existing workflows or workflow templates. A hardware or software processor executing instructions describing this application can, in step 1000, obtain an indication to use an artificial intelligence to create a workflow within a software platform, where the workflow includes at least three of a database, a view of the database, a connection, an automation, an artificial intelligence action, a setting, and a template metadata. The indication can include a natural language input describing an output based on an input.

In step 1010, the processor can obtain existing components including at least three of an existing workflow, an existing database, an existing view of the database, an existing connection, an existing automation, an existing artificial intelligence action, an existing setting, and an existing template metadata.

In step 1020, the processor can use the artificial intelligence to analyze the natural language input and to determine needed components to produce the output, where the needed components include at least three of a needed workflow to produce the output, a needed database to produce the output, a needed view of the database to produce the output, a needed connection to produce the output, a needed automation to produce the output, a needed artificial intelligence action to produce the output, a needed setting to produce the output, or a needed template metadata to produce the output.

In step 1030, the processor can determine, among the existing components matching components to the needed components, where the matching components include at least three of a matching workflow, a matching database, a matching view of the database, a matching connection, a matching automation, a matching artificial intelligence action, a matching setting, and a matching template metadata.

In step 1040, the processor can create the needed workflow to produce the output.

To determine the matching components to the needed components, the processor can obtain a first multiplicity of embedding vectors representing at least a subset of the existing components, where a first embedding vector among the first multiplicity of embedding vectors is a first numerical vector in multidimensional space. The processor can obtain a second embedding vector representing a needed component among the needed components, where the second embedding vector is a second numerical vector in the multidimensional space. The processor can obtain multiple measures of similarity between the second embedding vector and the first multiplicity of embedding vectors, where a measure of similarity between the multiple measures of similarity indicates similarity between the second embedding vector and the first embedding vector. The processor can prompt an artificial intelligence trained to determine the measures of similarity to obtain the multiple measures of similarity. The processor can rank the first multiplicity of embedding vectors according to the multiple measures of similarity to obtain multiple ranked embedding vectors, where the ranking can be from highest to lowest similarity. The processor can obtain a predetermined number of embedding vectors from the multiple ranked embedding vectors, such as top 100 most similar embedding vectors. The processor can obtain corresponding existing components represented by the predetermined number of embedding vectors. The processor can provide the corresponding existing components and the needed component to a large language model configured to provide multiple similarity scores. The processor can obtain the multiple similarity scores from the large language model and can determine a matching component to the needed component based on the multiple similarity scores. For example, the processor can rank the corresponding existing components based on the multiple similarity scores.

The processor can obtain information about a first user providing the natural language input, a context associated with the needed workflow including whether the needed workflow is part of a workspace or a teamspace, and an indication of a connected tool to the workspace. A “workspace” can be the overall container for all information, while a “teamspace” is a smaller, dedicated space within the workspace designed to organize and manage specific teams or projects, allowing for more granular access control and customized organization for each team within the larger workspace. Essentially, a teamspace is like a mini workspace within a workspace with its own permissions and structure. The processor can obtain information about a second user using one or more of the existing components and a context associated with the one or more existing components. Based on the information about the first user, the context associated with the needed workflow, the information about the second user, and the context associated with the one or more existing components, the processor can determine one or more of the matching components.

The processor can receive a selection of one or more of the needed components including at least three of the needed workflow to produce the output, the needed database to produce the output, the needed view of the database to produce the output, the needed connection to produce the output, the needed automation to produce the output, the needed artificial intelligence action to produce the output, the needed setting to produce the output, and the needed template metadata to produce the output. The processor can receive an indication of a user who does not have access to the selected one or more of the needed components. The user can be a single user, a group of users such as a workspace, and/or the software platform marketplace. The processor can share the selected one or more of the needed components with the user.

Upon analyzing the natural language input to determine the needed components to produce the output, the processor can create a needed code to produce the output or an integration with a software tool external to the software platform. For example, the processor can write the necessary JavaScript code, create or connect to databases, and/or set up integrations with external tools like Slack. The processor can create a test to verify that the needed workflow produces the output. The processor can enable the user providing a natural language input to iterate on creation of the needed workflow through natural conversation by providing natural language explanations of creation of the needed workflow.

The processor can create the needed workflow to produce the output by creating the needed automation, where the needed automation includes a trigger, an action, and a run history. The trigger can describe an event upon which occurrence the action is performed. For example, triggers can describe specific events to watch for, like “when a row is added to this database” or “when someone posts in this Slack channel.” When triggers fire, the workflow runs actions that can be JavaScript functions that can interact with the software platform, external tools, and AI. The action can include a call to an application programming interface, a source code, or an English language description of the source code. The call to the application programming interface can be a call to an internal or external application programming interface. The run history includes a log of executions of the automation.

The processor can obtain the existing components including the existing artificial intelligence action, where the existing artificial intelligence action includes a log of an artificial intelligence prompt and a resulting modification.

### Customizing a Workflow in a Software Platform Using Artificial Intelligence

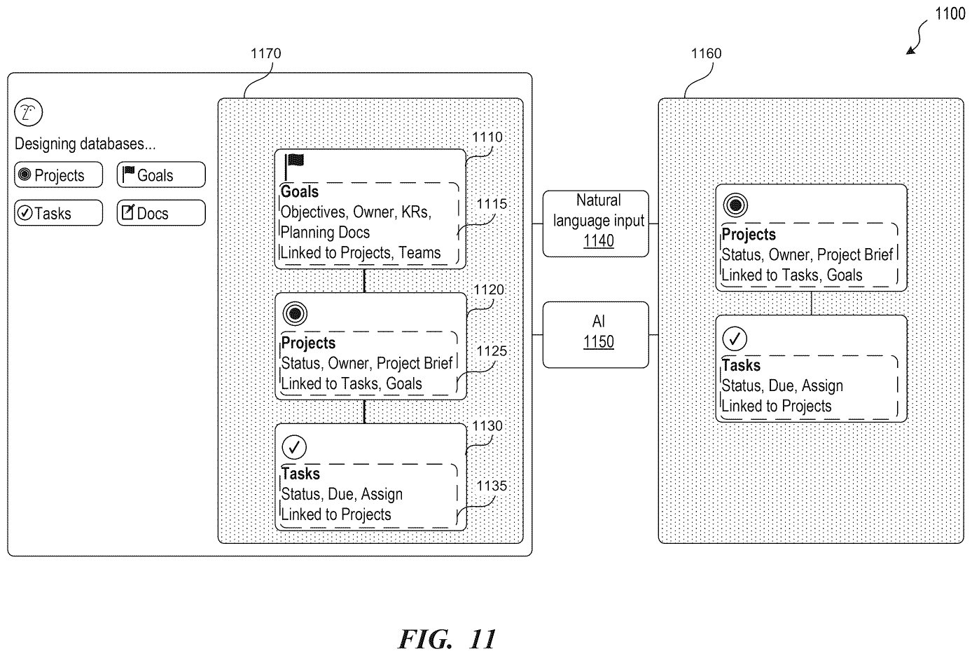

FIG. 11 shows a system to customize an existing workflow using natural language prompts. As explained in this application in FIG. 4, the system 1100 can present the plan 430 in FIG. 4 including natural language description 1115, 1125, 1135 of components 1110, 1120, 1130 to be included in the workflow 1170. The system 1100 can enable the user to interact with an artificial intelligence 1150 and provide natural language input 1140 describing modifications to the proposed workflow 1170.

The natural language input 1140 can describe changes such as “add a view of the project sorted by owner” or “remove goals from the plan.” The AI 1150 can analyze the natural language input 1140, make the specified changes, and present the new plan, e.g., plan 1160, to the user.

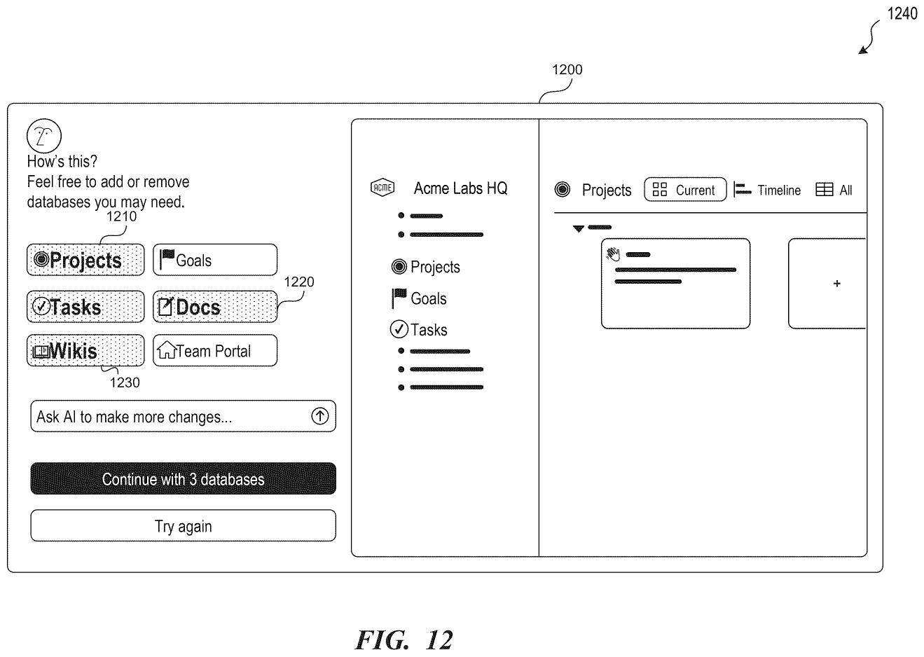

FIG. 12 shows an interface to customize an existing workflow. Upon receiving the natural language input 1140 in FIG. 11, the AI 1150 in FIG. 11 can provide the graphical user interface 1200, which can enable the user to modify the plan 430 in FIGS. 4, 1160 in FIG. 11. The system 1240 can receive a selection of components 1210, 1220, 1230 (only three labeled for brevity) to include or to remove from the needed workflow. Based on the selection of components 1210, 1220, 1230, the system 1240 can create the needed workflow.

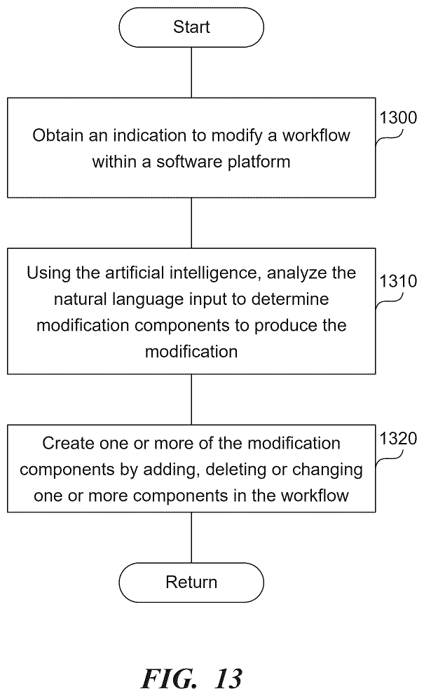

FIG. 13 is a flowchart of a method to customize a workflow in a software platform using artificial intelligence. A hardware or software processor executing instructions describing this application can, in step 1300, obtain an indication to modify a workflow within a software platform, where the workflow includes components including at least three of a database, a view of the database, a connection, an automation, an artificial intelligence action, a setting, and a template metadata and where the indication to modify the workflow includes a natural language input describing a modification to the workflow.

In step 1310, the processor can use the artificial intelligence to analyze the natural language input and to determine modification components to produce the modification. Modification can include addition, deletion, or a change to a component. The modification components can include a modification workflow, a modification database, a modification view of the database, a modification connection, a modification automation, a modification artificial intelligence action, a modification setting, or a modification template metadata.

In step 1320, the processor can create one or more of the modification components by adding, deleting, or changing one or more components in the workflow.

The processor can provide a parameterized prompt to a user, where the parameterized prompt includes a natural language statement with an insertion indication associated with a change to the natural language statement. The processor can receive, from the user, the change to the natural language statement. Based on the parameterized prompt and change to the natural language statement, the processor can generate the natural language input describing the modification to the workflow.

The processor can obtain information about the user generating the natural language input describing the modification to the workflow, information about a location of the workflow in a hierarchical organization of a workspace in which the workflow is located, or a template associated with the one or more of the modification components. The processor can enrich the natural language input describing the modification to the workflow with the information about the user generating the natural language input describing the modification to the workflow, the information about the location of the workflow in the hierarchical organization of the workspace in which the workflow is located, or the template associated with the one or more of the modification components. The processor can provide the enriched natural language input to the artificial intelligence.

The processor can show visualization of planned steps and allow users to edit before committing to generation or direct edits. Prior to creating the one or more of the modification components, the processor can provide a visualization of the components associated with the workflow including at least three of the database, the view of the database, the connection, the automation, and the artificial intelligence action. The processor can obtain a change to the provided components. The processor can incorporate the change of the provided components into the one or more of the modification components. The processor can create the one or more of the modification components.

The processor can receive a selection of one or more of the modification components including the modification workflow, the modification database, the modification view of the database, the modification connection, the modification automation, the modification artificial intelligence action, the modification setting, and the modification template metadata. The processor can receive an indication of a user who does not have access to the selected one or more of the modification components. The user can be a group of users, such as a workspace or the software platform marketplace. The processor can share the selected one or more of the modification components with the user.

The processor can obtain the indication to modify the workflow within the software platform, where the automation includes a trigger, an action, and a run history and where the trigger describes an event upon which occurrence the action is performed. A trigger describes specific events to watch for, such as “when a row is added to this database” or “when someone posts in this Slack channel.” When triggers fire, the workflow runs actions; these are actual JavaScript functions that can interact with the software platform tools and AI. The action can include a call to an application programming interface, a source code, or an English language description of the source code. The call to the application programming interface can be a call to an internal or an external application programming interface. The run history includes a log of executions of the automation.

A log of a program execution can include various types of information that help in understanding the behavior and performance of the program. Typically, it may contain timestamps indicating when specific events occurred, such as the start and end times of the program or particular functions within the program. It also includes detailed descriptions of events, such as function calls, exceptions, errors, and warnings. Additionally, the log may provide information about the data being processed, including inputs received and outputs generated by the program. Metrics related to the usage of system resources like CPU, memory, and disk I/O can help in performance analysis. Debugging information, such as variable values, stack traces, and execution flow, is also commonly included. Furthermore, if applicable, the log may record user interactions with the program, such as button clicks or command inputs. These elements collectively provide a comprehensive view of the program's execution, aiding in debugging, performance tuning, and understanding the program's behavior.

### User Interface for Creating a Workflow from a Natural Language Prompt Using Artificial Intelligence

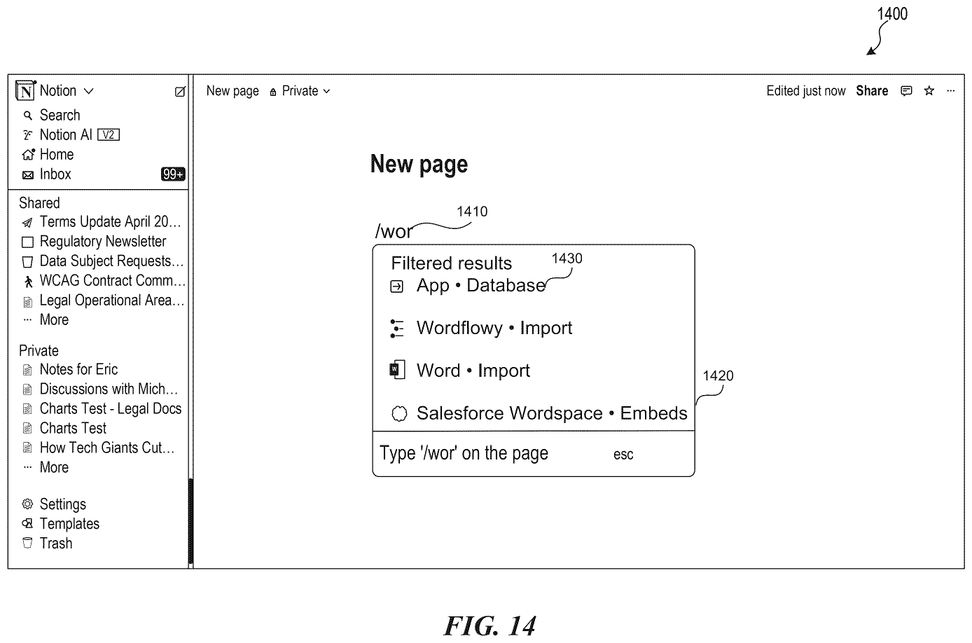

FIG. 14 shows a user interface to invoke the system to build a workflow as described in this application. The user interface 1400 can be a graphical user interface as shown and/or can be an audio user interface enabling the user to interact through voice. When the user interface 1400 receives an appropriate input 1410, such as “/wor”, the user interface 1400 can provide the user interface element 1420, which indicates various auto completions for the input 1410. Upon receiving a selection of the auto completion 1430, namely “App” indicating the workflow, e.g., software application or “app,” the user interface 1400 proceeds to provide a user interface to create the workflow as described below.

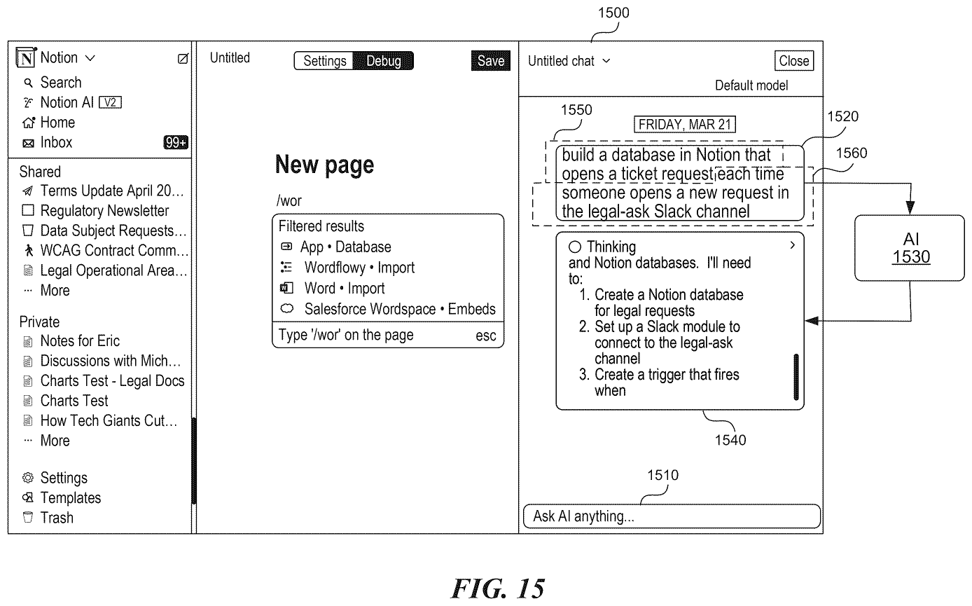

FIG. 15 shows a user interface to create a workflow. The user interface 1500 provides a user interface element 1510 which accepts natural language input 1520 describing the workflow to create. The natural language input 1520 states “build a database in notion that opens the ticket request each time someone opens a new request in the legal-ask Slack channel.”

The natural language input 1520 can include an action, e.g. output, 1550, namely an output, “build a database in notion that opens the ticket request,” and a trigger 1560, namely an input, “someone opens a new request in the legal-ask Slack channel.” The output 1550 can specify the component to bill, such as a database, a notification, etc.

An AI 1530 analyzes the natural language input 1520 to determine the next steps 1540. The AI 1530 can provide the next steps 1540 in the user interface 1500. The next steps 1540 can state:
1. Create a Notion Database for Legal Requests.
2. Set up a Slack module to connect to the legal-ask channel
3. Create a trigger that fires . . .

The AI 1530 can proceed to perform the described steps. The user interface 1500 can scroll through the next steps 1540 to not take up too much screen space with the “thinking” of the AI 1530.

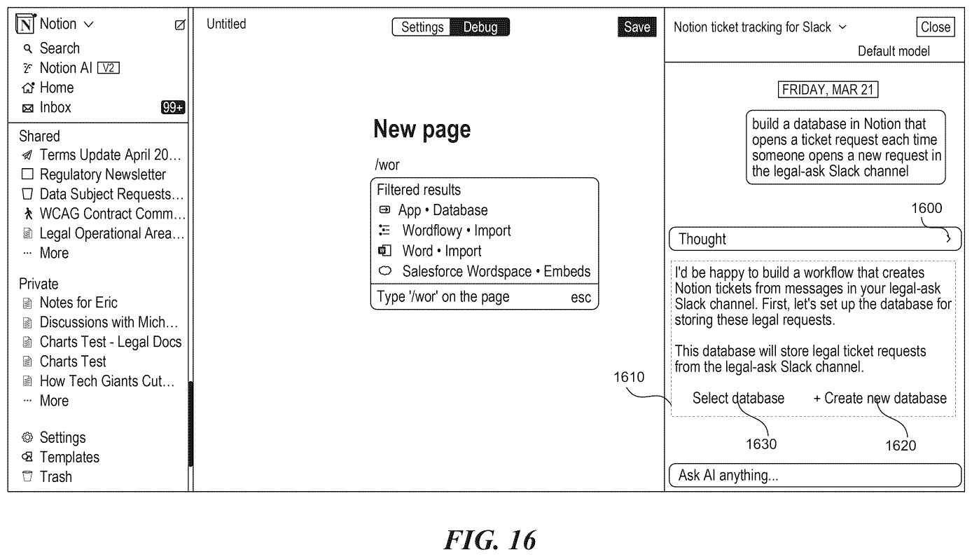

FIG. 16 shows execution of an initial step determined by the AI 1530 in FIG. 15. The user interface element 1600, when selected, enables the user to see the list of next steps 1540 in FIG. 15 that the AI 1530 determines need to be taken to produce the requested output 1550 in FIG. 15.

The user interface element 1610 can provide the status of progress in creating the requested output 1550. In addition, the user interface element 1610 can prompt the user to provide an input such as whether to create a new database by selecting the user interface element 1620 or whether to use an existing database by selecting the user interface element 1630.

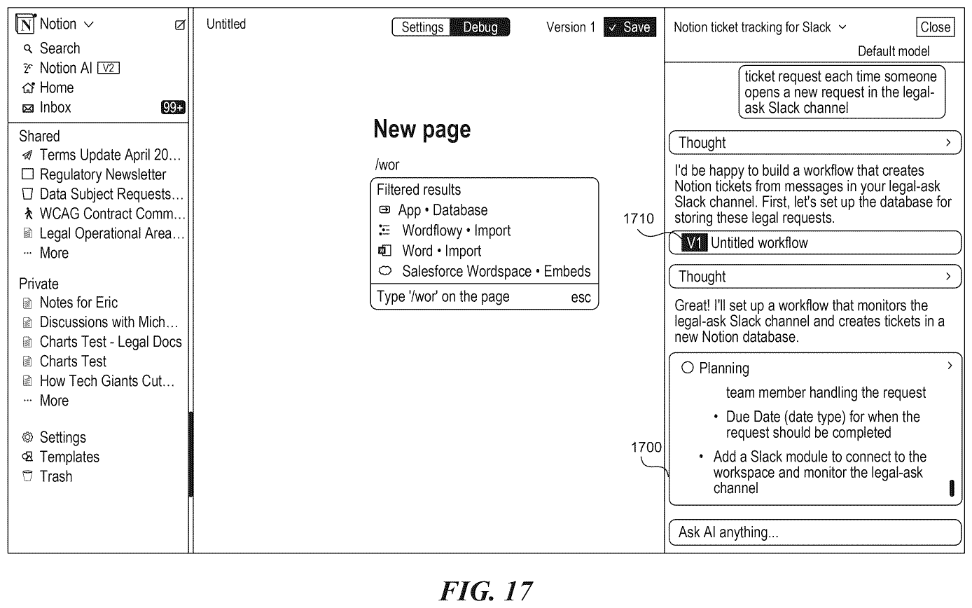

FIG. 17 shows the user interface once the user selects the appropriate user interface element 1620, 1630 in FIG. 16. In the specific case of FIG. 17, the user has selected the user interface element 1630, which indicates to create a new database. The AI 1530 in FIG. 15 continues to provide, in the user interface element 1700, the list of steps the AI is planning to take to provide the requested output 1550 in FIG. 15. The user interface element 1710 can indicate iterations have been made to the requested output 1550. As can be seen in FIG. 17, there has been only one iteration.

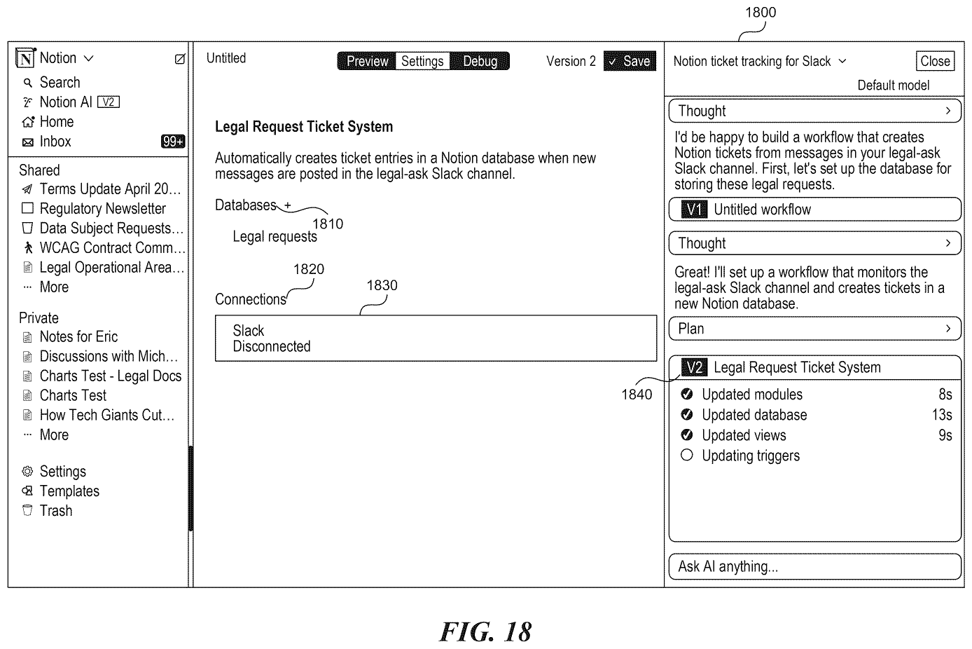

FIG. 18 shows the user interface including the created components. The user interface 1800 provides the components such as database 1810 and connection 1820 that are created based on the natural language input 1520 in FIG. 15. The component 1820 is a connection between the database 1810 and a third-party application such as Slack. In addition to showing the components such as database 1810 and connection 1820, the user interface 1800 can provide a visualization 1830 showing the status of the connection 1820, which in FIG. 18 is disconnected. The visualization 1830 can be selected, and when selected can enable the user to establish a connection between the database 1810 and Slack. User interface element 1840 can indicate that there have been 2 iterations to the requested output 1550 in FIG. 15.

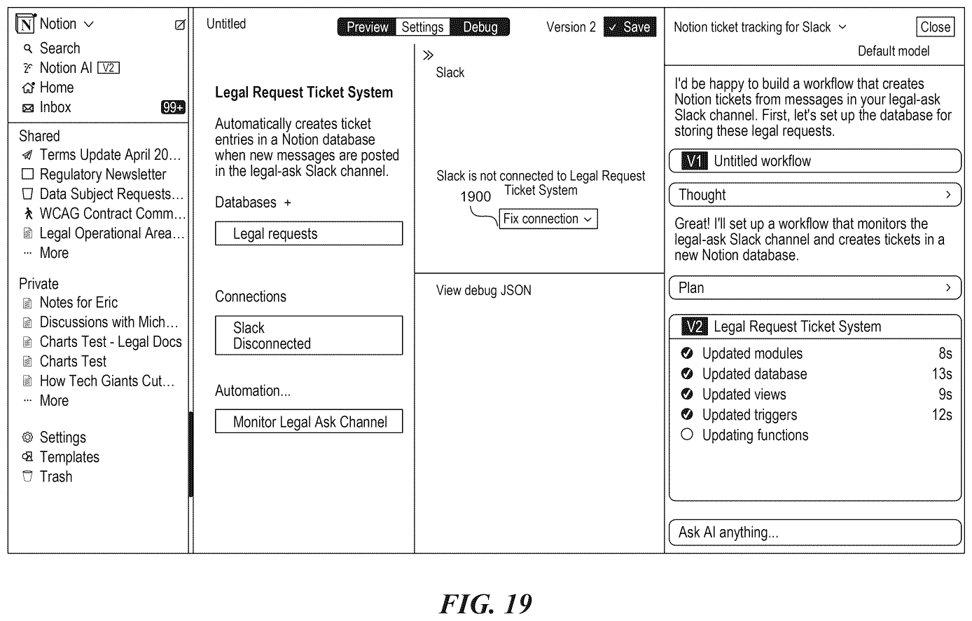

FIG. 19 shows a user interface element to repair the connection between an input and an output. Upon receiving a selection of the user interface element 1830, the system, upon the selection of user interface element 1900, can attempt to initiate repair of the connection 1820 between the input, e.g. trigger, 1560 in FIG. 1 and the output 1550 in FIG. 1.

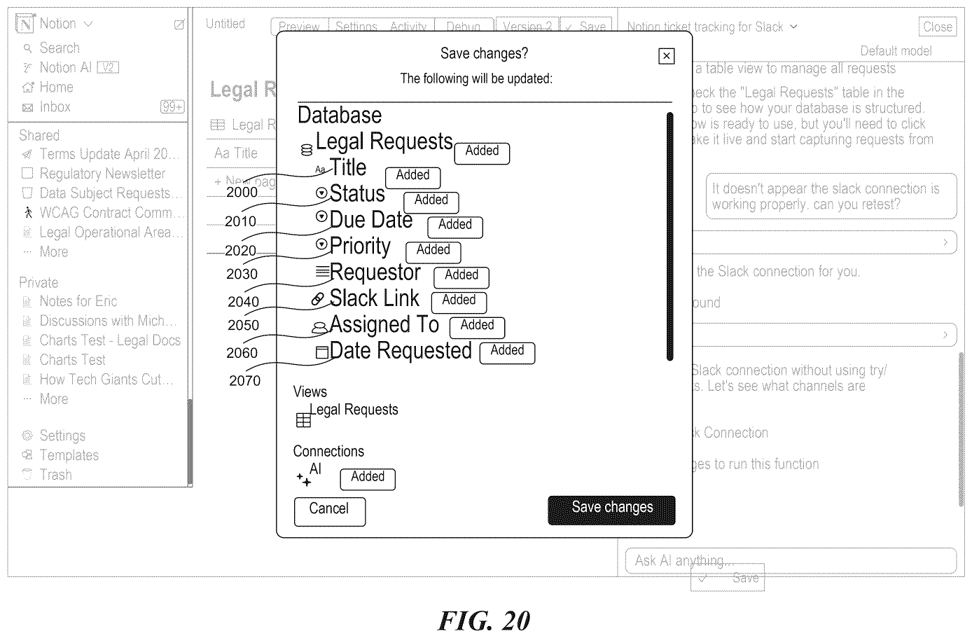

FIG. 20 shows the user interface enabling a user to select properties to include in the output. When the requested output 1550 in FIG. 1 includes a database, prior to creating a visualization of the database, the system can ask the user to select which properties to include in the database, such as title 2000, status 2010, due date 2020, priority 2030, requestor 2040, Slack Link 2050, assigned to 2060, and date requested 2070.

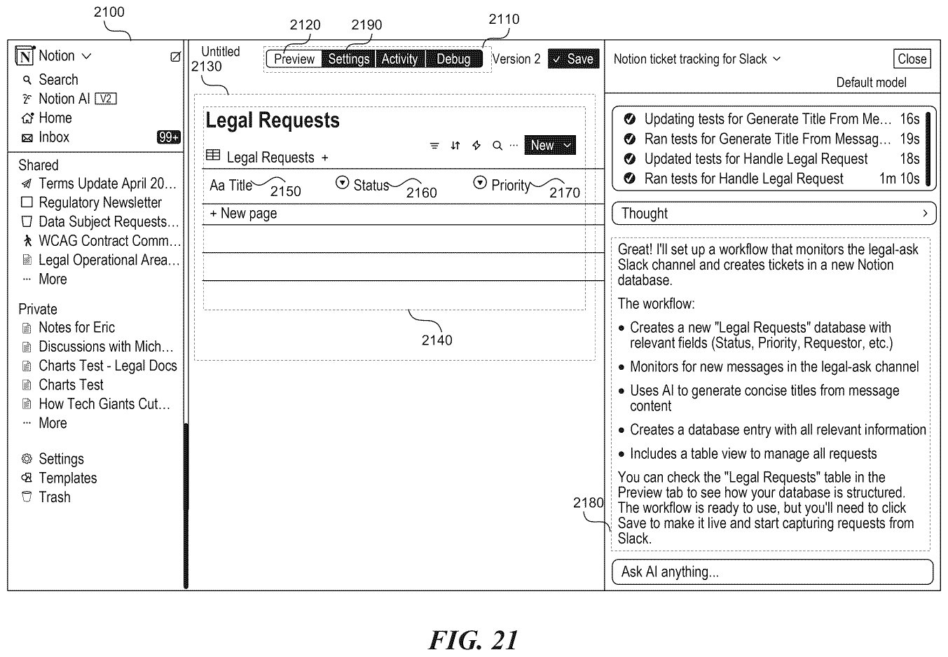

FIG. 21 shows a visualization of the output. The user interface 2100 can include a user interface element 2110 enabling the user to switch between a preview of the visualization 2130 and a view of the components 1810, 1820 in FIG. 18 by selecting user interface element 2120, 2190, respectively. In other words, when a user selects user interface element 2120, the user interface 2100 shows a preview of the visualization 2130 of the output, e.g., the workflow. The visualization 2130 shows a database 2140 that includes multiple properties 2150, 2160, 2170.

In addition, the user interface 2100 can include an explanation 2180, provided by the AI 1530 in FIG. 15, of the created output including: “The workflow:
Creates a new “legal requests” database with relevant fields (status, priority, requester, etc.)
Monitors for new messages in the legal-ask channel
Uses AI to generate concise titles for message content
Creates the database entry with all relevant information
Includes a table view to manage all requests.”

As can be seen from the explanation 2180, without instructions to do so, the AI 1530 created a property “title” that is automatically generated from the message content of the message that activates the trigger 1560 in FIG. 15 and generates a record in the database 2140.

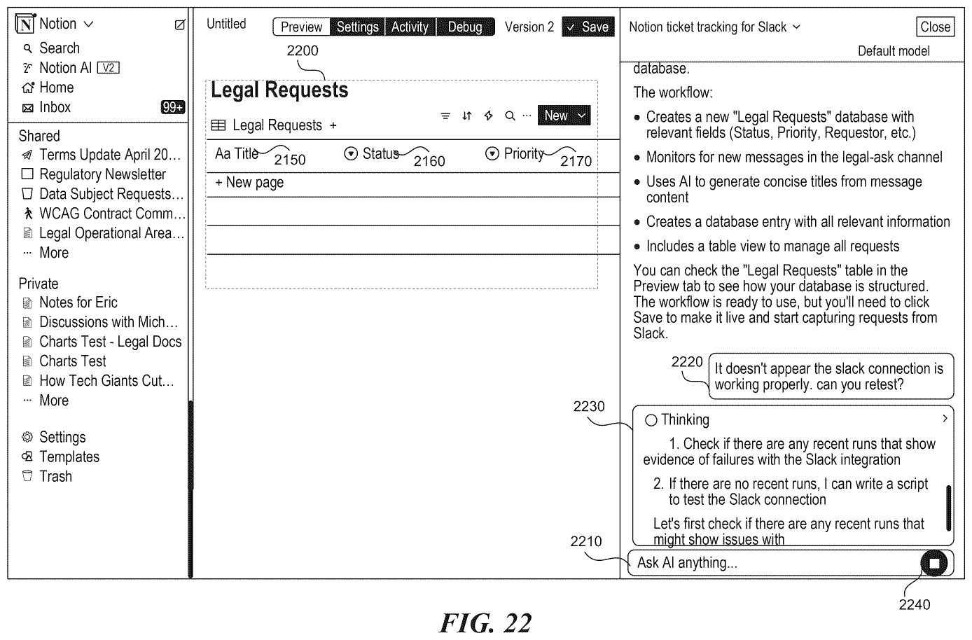

FIG. 22 shows using natural language input to debug the output. The output 2200 does not show any values for the properties 2150, 2160, 2170, indicating that there is no connection between the input, namely the Slack channel, and the output, namely the database.

The system enables a user to debug the problem using natural language, as opposed to computer programming or specialized software tools for debugging. The user interface elements 2210 enables the user to enter a natural language input 2220 describing an issue associated with the output, such as “it doesn't appear the Slack connection is working properly. Can you retest?”

The AI 1530 in FIG. 15 can analyze the natural language input 2220 and can provide a natural language description 2230 indicating a fix to the issue. For example, the natural language description 2230 can include the debugging steps in state “1. Check if there are any recent runs that show evidence of failures with the Slack integration. 2. If there are no recent runs, I [meaning the AI] can write a script to test the Slack connection.” The fix to the issue does not have to involve any actions from the user, and the AI for 1530 can provide the issue just for informative purposes. If the user wants to prevent the AI 1530 from performing any additional steps, the user can select the user interface element 2240.

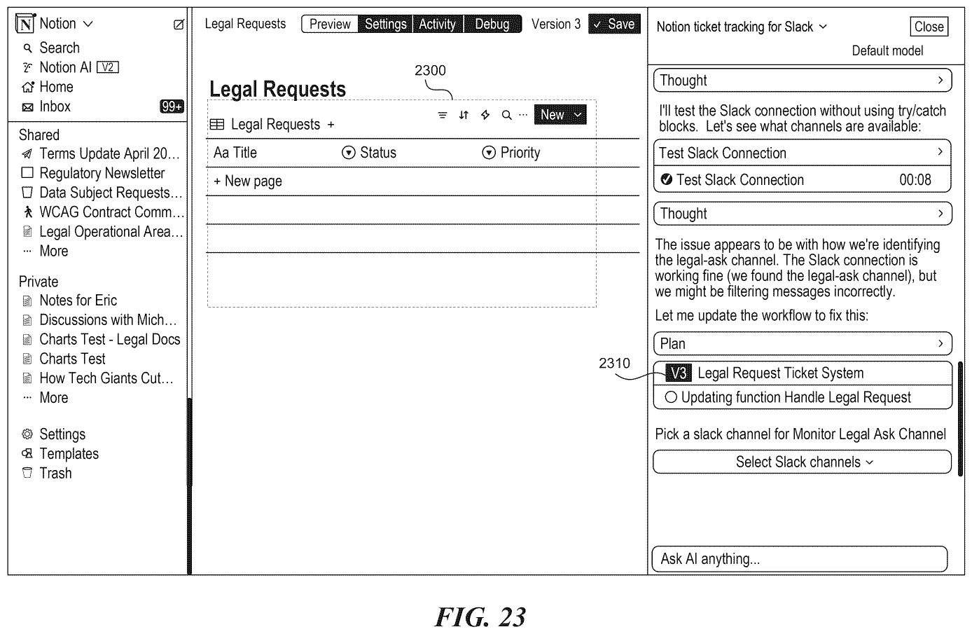

FIG. 23 shows results of the debugging steps expressed as natural language description 2230 in FIG. 22. After performing the identified debugging steps 2230, the AI can provide the results, e.g., the conclusion, obtained from the debugging steps, namely “the issue appears to be with how we are identifying the legal-ask channel. The Slack connection is working fine (we found the legal-ask channel), but we might be filtering messages incorrectly.” In other words, the AI 1530 is saying that the connection between the legal-ask Slack channel and the database 2300 works but that identifying messages in the Slack channel that are “new requests” and should trigger populating the database 2300 is not working. The AI 1530 then proceeds to properly identify “new requests” messages. Note that the user interface element 2310 shows the current iteration, e.g., version, of the database 2300.

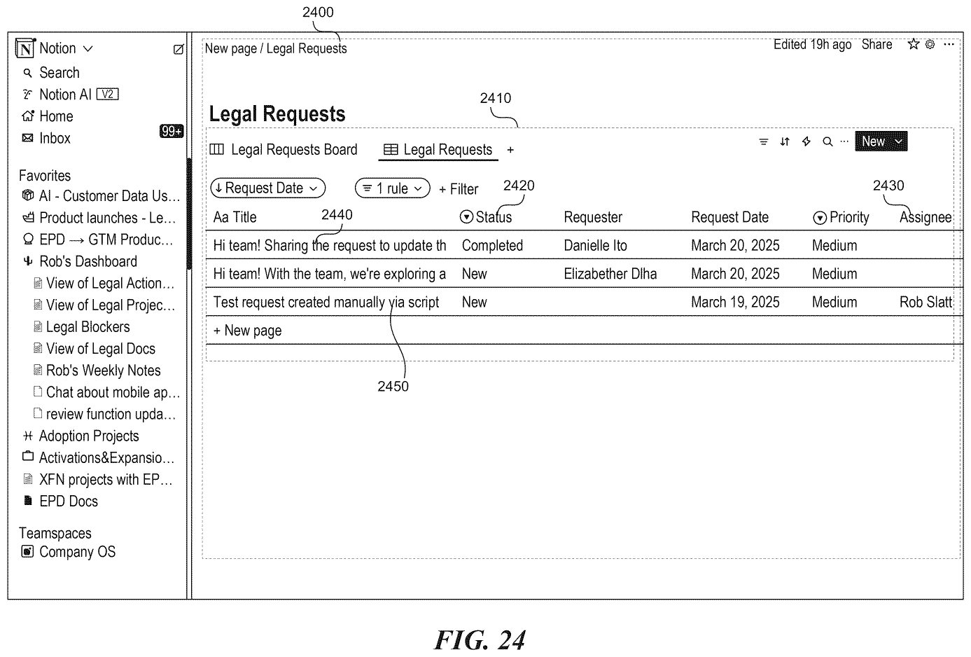

FIG. 24 shows a visualization of the requested output. The visualization 2400 shows the database 2410 including multiple properties 2420, 2430 (only 2 labeled for brevity) corresponding to the columns in the database, and multiple records 2440, 2450 corresponding to the rows in the database.

The property 2420, titled Status can be automatically updated based on the messages exchanged on Slack. Similarly, the property 2430, titled Assignee, can be automatically updated. Specifically, AI 1530 can automatically determine who the assignee of a new request should be based on the content of the new request and the expertise of each team member. The expertise of each team member can be recorded in another database.

Generally, the AI, with or without being prompted, can automatically update properties 2420, 2430 in the database 2410. For example, the AI, with or without being prompted, can create connections between properties 2420, 2430 in the database and messages in Slack and/or other databases.

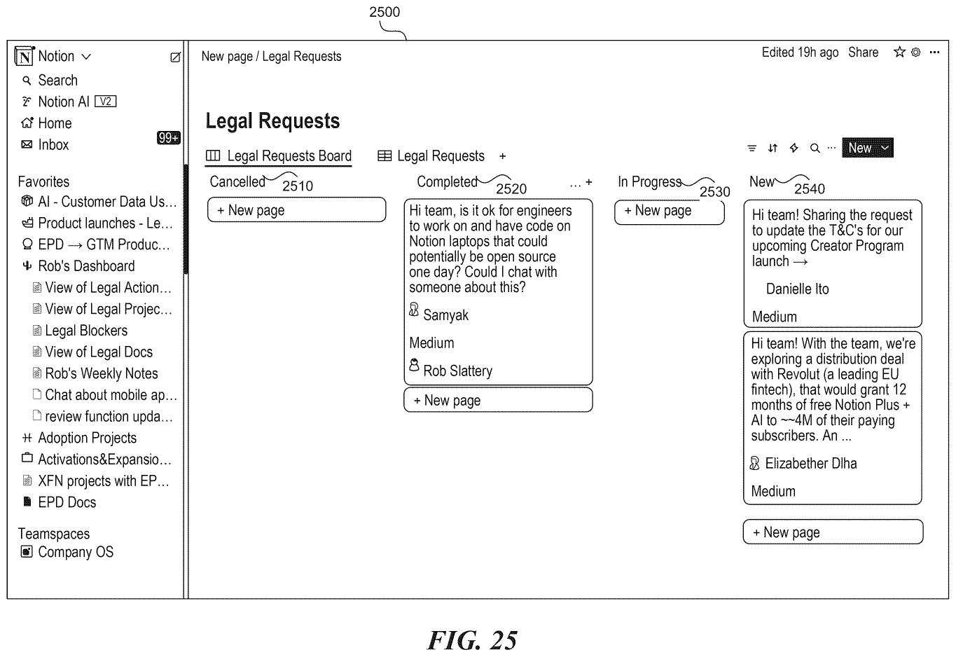

FIG. 25 shows a view of the output created without prompting. As shown in FIG. 25, the output includes a database 2410 in FIG. 24. The database can have multiple views, such as the view shown in FIG. 24 showing multiple properties 2420, 2430 and multiple records 2440, 2450. FIG. 25 shows a different view 2500 of the database. The AI 1530 in FIG. 15 can create the view 2500 without being explicitly prompted, e.g., requested, to create this view. The AI 1530 can determine the most relevant property 2420 in FIG. 24 to show in the view 2500. The AI 1530 can determine the most relevant property by examining views associated with other databases and frequency of accessing those views. So, the AI 1530 can determine that the status property 2420 is the most relevant and generate the view 2500.

The view 2500 shows the status of property 2420 in FIG. 24, which can take on multiple values 2510, 2520, 2530, 2540. The view can show which records 2440, 2450 have which particular values 2510, 2520, 2530, 2540, by for example showing the record 2440 as having value 2520 and the record 2450 as having value 2540.

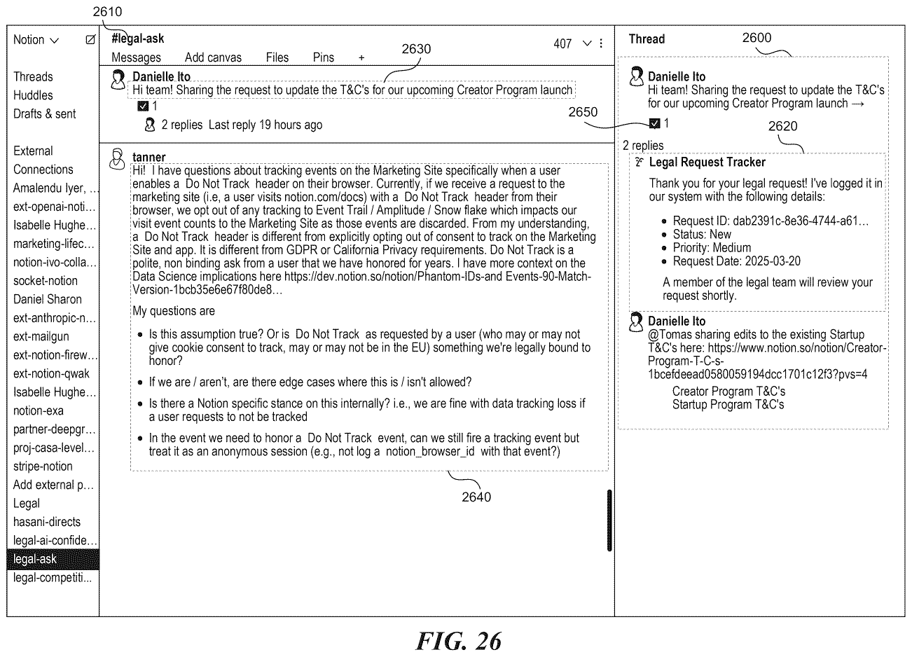

FIG. 26 shows results of an action that the AI performed without prompting and a change to the action. Without being the instructed to do so, AI 1530 in FIG. 15, upon creating the database requested in the output, also created updates 2600 in the Slack channel 2610 legal-ask. The updates 2600 include unrequested features such as providing the information 2620 about tickets opened in the database as well as a checkmark 2650 indicating that the ticket has been logged in a database.

For example, the system receives the request 2630 in the legal-ask channel 2610, where the request 2630 states “Hi team! Sharing the request to update . . . ” (Emphasis added). The AI 1530, after receiving the natural language input 1520 in FIG. 15, identifies that the request 2630 is a type of message that meets the input 1520 requirements. Consequently, the AI 1530 processes the request 2630 and creates an appropriate record 2440 in FIG. 24.

The user can provide a natural language prompt to instruct the AI 1530 to remove those features by stating, for example, “do not provide updates of logged features in the Slack channel.” The AI 1530 can analyze the received natural language input and can remove the code producing undesired results. As can be seen in FIG. 26, the AI 1530 has removed the code creating the updates 2620 and in the Slack channel 2610 because the next time the AI 1530 receives a request 2640 in the Slack channel 2610, the AI 1530 does not provide any updates regarding the request 2640.

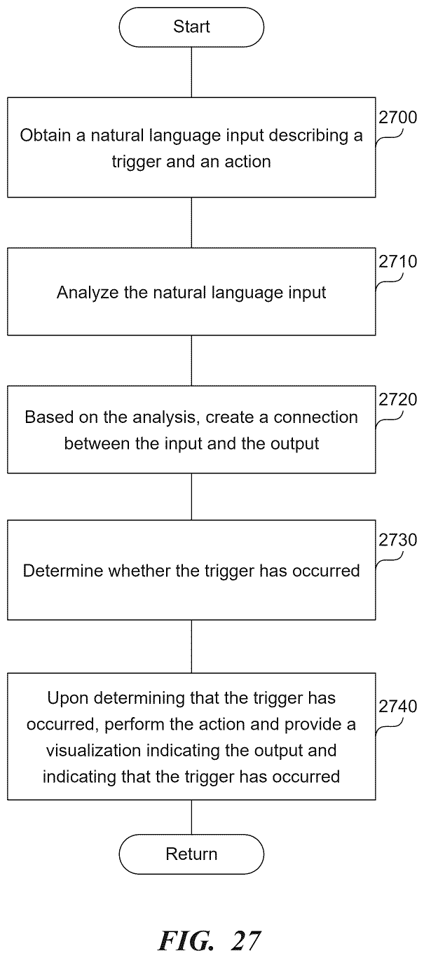

FIG. 27 is a flowchart of a method to create a software application, e.g., a workflow, using a natural language prompt. A hardware or software processor executing instructions describing this application can in step 2700 obtain a natural language input describing a trigger and an action. The trigger can include an indication of an input, such as customer feedback, customer comments, bug reports, new requests on a particular channel, etc. The action can include an indication of an output such as a notification in a particular channel, a database or webpage to track various items, computer code to execute, etc. The action can be performed upon an occurrence of the trigger.

In step 2710, the processor can analyze the natural language input, and in step 2720, based on the analysis, the processor can create a connection between the input and the output. Creating the connection between the input and the output includes creating and executing computer code without requiring the user to directly specify the computer code. In other words, the user does not need to be a programmer or know how to code at all and can create the necessary code 3 natural language prompting of the AI.

In step 2730, the processor can determine whether the trigger has occurred. In step 2740, upon determining that the trigger has occurred, the processor can perform the action and provide a visualization indicating the output and indicating that the trigger has occurred.

The processor can provide the visualization indicating the output and a status of the connection between the input and the output. The output can be the database as seen in FIG. 18. When the connection between the input and the output is disconnected, the processor can provide a user interface element to repair the connection between the input and the output. Upon receiving a selection of the user interface element to repair the connection, the processor can initiate repair of the connection between the input and the output.

The processor can provide a user interface element configured to receive a second natural language input and can receive the second natural language input describing an issue associated with the output, such as that the connection between the input and the output does not seem to work. The processor can analyze the second natural language input. Based on the analysis, the processor can provide a natural language description indicating a fix to the issue.

Based on the natural language input, the processor can provide a database, where the output includes the database. Based on the input associated with the natural language input, the processor can create a property in the database. The processor can receive a second natural language input describing a second input and a second output, where the second output includes the property in the database. The processor can establish a second connection between the second input and the property in the database, where the second connection automatically updates the second property in the database based on the second input. The second property in the database can be “status” or “assignee.” Effectively, the processor can create nested connections through natural language prompting. Alternatively, the processor can create nested connections without being prompted to create the second level connection. Specifically, the processor can automatically create the property “title” by summarizing the message that is entered as a record in the database.

Based on the natural language input, the processor can provide a database, where the output includes the database. The database can include multiple properties and multiple records, where a record among the multiple records includes a value associated with a property among the multiple properties. The database can provide a view associated with the database without being prompted to provide the view by the natural language input, where the view is associated with a particular property among the multiple properties in the database. The particular property can be configured to assume multiple values. The view shows the multiple values and a record among the multiple records associated with a particular value among the multiple values.

The processor can obtain from the artificial intelligence an indication of a list of steps to perform to satisfy the natural language input and can provide the list of steps to a user.

Based on the natural language input, the processor can provide a database, which can be included in the output. The database can include multiple properties. The processor can provide the multiple properties to the user and a user interface enabling the user to modify the multiple properties. The processor can receive a user input indicating whether to modify a property among the multiple properties. Based on the user input in the multiple properties, the processor can create the database.

### Computer System

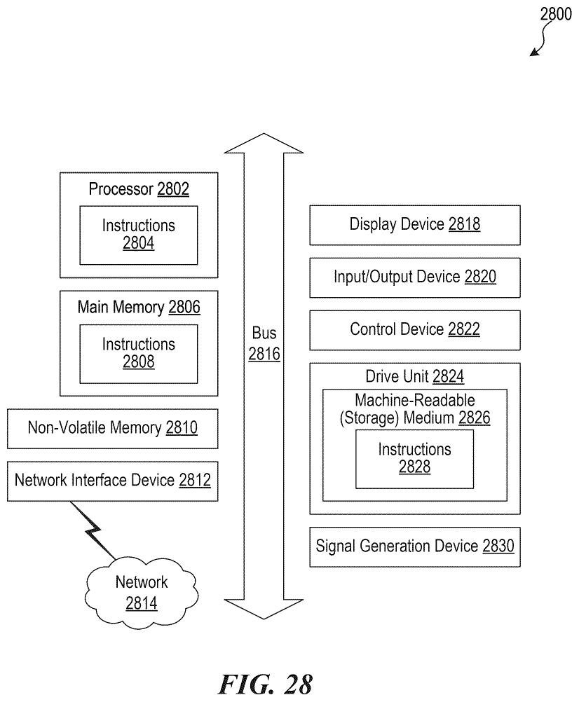

FIG. 28 is a block diagram that illustrates an example of a computer system 2800 in which at least some operations described herein can be implemented. As shown, the computer system 2800 can include one or more processors 2802, main memory 2806, non-volatile memory 2810, a network interface device 2812, a display device 2818, an input/output device 2820, a control device 2822 (e.g., keyboard and pointing device), a drive unit 2824 that includes a machine-readable (storage) medium 2826, and a signal generation device 2830 that are communicatively connected to a bus 2816. The bus 2816 represents one or more physical buses and/or point-to-point connections that are connected by appropriate bridges, adapters, or controllers. Various common components (e.g., cache memory) are omitted from FIG. 28 for brevity. Instead, the computer system 2800 is intended to illustrate a hardware device on which components illustrated or described relative to the examples of the Figures and any other components described in this specification can be implemented.

The computer system 2800 can take any suitable physical form. For example, the computer system 2800 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 2800. In some implementations, the computer system 2800 can be an embedded computer system, a system-on-chip (SOC), a single-board computer (SBC) system, or a distributed system such as a mesh of computer systems or include one or more cloud components in one or more networks. Where appropriate, one or more computer systems 2800 can perform operations in real time, near real time, or batch mode.

The network interface device 2812 enables the computer system 2800 to mediate data in a network 2814 with an entity that is external to the computer system 2800 through any communication protocol supported by the computer system 2800 and the external entity. Examples of the network interface device 2812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 2806, non-volatile memory 2810, machine-readable medium 2826) can be local, remote, or distributed. Although shown as a single medium, the machine-readable medium 2826 can include multiple media (e.g., a centralized/distributed database and/or associated caches and servers) that store one or more sets of instructions 2828. The machine-readable medium 2826 can include any medium that is capable of storing, encoding, or carrying a set of instructions for execution by the computer system 2800. The machine-readable medium 2826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 2810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 2804, 2808, 2828) set at various times in various memory and storage devices in computing device(s). When read and executed by the processor 2802, the instruction(s) cause the computer system 2800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variant thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
obtain, by an artificial intelligence from a user, a natural language input describing a trigger and an action,
wherein the trigger includes an indication of an input,
wherein the action includes an indication of an output, and
wherein the action is performed upon an occurrence of the trigger;
analyze, by the artificial intelligence, the natural language input;
based on the analysis of the natural language input, create, by the artificial
intelligence, a connection between the input and the output,
wherein creating the connection between the input and the output includes creating and executing computer code without requiring the user to directly specify the computer code;
determine whether the trigger has occurred; and
upon determining that the trigger has occurred, perform the action and provide a visualization indicating the output and indicating that the trigger has occurred.

2. The non-transitory, computer-readable storage medium of claim 1, comprising instructions to:
provide the visualization indicating the output and a status of the connection between the input and the output;
when the connection between the input and the output is disconnected, provide a user interface element to repair the connection between the input and the output; and
upon receiving a selection of the user interface element to repair the connection, initiate repair of the connection between the input and the output.

3. The non-transitory, computer-readable storage medium of claim 1, comprising instructions to:
provide a user interface element configured to receive a second natural language input;
receive the second natural language input describing an issue associated with the output;
analyze the second natural language input; and
based on the analysis of the second natural language input, provide a natural language description indicating a fix to the issue.

4. The non-transitory, computer-readable storage medium of claim 1, comprising instructions to:
based on the natural language input, provide a database,
wherein the output includes the database;
based on the input associated with the natural language input, create a property in the database;
receive a second natural language input describing a second input and a second output,
wherein the second output includes the property in the database; and
establish a second connection between the second input and the property in the database,
wherein the second connection automatically updates the property in the database based on the second input.

5. The non-transitory, computer-readable storage medium of claim 1, comprising instructions to:
based on the natural language input, provide a database,
wherein the output includes the database,
wherein the database includes multiple properties and multiple records,
wherein a record among the multiple records includes a value associated with a property among the multiple properties; and
provide a view associated with the database without being prompted to provide the view by the natural language input,
wherein the view is associated with a particular property among the multiple properties in the database,
wherein the particular property is configured to assume multiple values, and
wherein the view shows the multiple values and a particular record among the multiple records associated with a particular value among the multiple values.

6. The non-transitory, computer-readable storage medium of claim 1, comprising instructions to:
obtain, from the artificial intelligence, an indication of a list of steps to perform to satisfy the natural language input; and
provide the list of steps to the user.

7. The non-transitory, computer-readable storage medium of claim 1, comprising instructions to:
based on the natural language input, provide a database,
wherein the output includes the database,
wherein the database includes multiple properties;
provide the multiple properties to the user and a user interface enabling the user to modify the multiple properties;
receive a user input indicating whether to modify a property among the multiple properties; and
based on the user input in the multiple properties, create the database.

8. A method comprising:
obtaining a natural language input describing a trigger and an action,
wherein the trigger includes an indication of an input,
wherein the action includes an indication of an output, and
wherein the action is performed upon an occurrence of the trigger;
analyzing the natural language input;
based on the analysis of the natural language input, creating a connection between the input and the output,
wherein creating the connection between the input and the output includes creating and executing computer code without requiring a user to directly specify the computer code;
determining whether the trigger has occurred; and
upon determining that the trigger has occurred, performing the action and providing a visualization indicating the output and indicating that the trigger has occurred.

9. The method of claim 8, comprising:
providing the visualization indicating the output and a status of the connection between the input and the output;
when the connection between the input and the output is disconnected, providing a user interface element to repair the connection between the input and the output; and
upon receiving a selection of the user interface element to repair the connection, initiating repair of the connection between the input and the output.

10. The method of claim 8, comprising:
providing a user interface element configured to receive a second natural language input;
receiving the second natural language input describing an issue associated with the output;
analyzing the second natural language input; and
based on the analysis of the second natural language input, providing a natural language description indicating a fix to the issue.

11. The method of claim 8, comprising:
based on the natural language input, providing a database,
wherein the output includes the database;
based on the input associated with the natural language input, creating a property in the database;
receiving a second natural language input describing a second input and a second output,
wherein the second output includes the property in the database; and
establishing a second connection between the second input and the property in the database, wherein the second connection automatically updates the property in the database based on the second input.

12. The method of claim 8, comprising:
based on the natural language input, providing a database,
wherein the output includes the database,
wherein the database includes multiple properties and multiple records,
wherein a record among the multiple records includes a value associated with a property among the multiple properties; and
providing a view associated with the database without being prompted to provide the view by the natural language input,
wherein the view is associated with a particular property among the multiple properties in the database,
wherein the particular property is configured to assume multiple values, and
wherein the view shows the multiple values and a particular record among the multiple records associated with a particular value among the multiple values.

13. The method of claim 8, comprising:
based on the natural language input, providing a database,
wherein the output includes the database,
wherein the database includes multiple properties;
providing the multiple properties to the user and a user interface enabling the user to modify the multiple properties;
receiving a user input indicating whether to modify a property among the multiple properties; and
based on the user input in the multiple properties, creating the database.

14. A system comprising:
at least one hardware processor; and
at least one non-transitory memory storing instructions, which, when executed by the at least one hardware processor, cause the system to:
obtain a natural language input describing a trigger and an action,
wherein the trigger includes an indication of an input,
wherein the action includes an indication of an output, and
wherein the action is performed upon an occurrence of the trigger;
analyze the natural language input;
based on the analysis of the natural language input, create a connection between the input and the output,
wherein creating the connection between the input and the output includes creating and executing computer code without requiring a user to directly specify the computer code;
determine whether the trigger has occurred; and
upon determining that the trigger has occurred, perform the action and provide a visualization indicating the output and indicating that the trigger has occurred.

15. The system of claim 14, comprising instructions to:
provide the visualization indicating the output and a status of the connection between the input and the output;
when the connection between the input and the output is disconnected, provide a user interface element to repair the connection between the input and the output; and
upon receiving a selection of the user interface element to repair the connection, initiate repair of the connection between the input and the output.

16. The system of claim 14, comprising instructions to:
provide a user interface element configured to receive a second natural language input;
receive the second natural language input describing an issue associated with the output;
analyze the second natural language input; and
based on the analysis of the second natural language input, provide a natural language description indicating a fix to the issue.

17. The system of claim 14, comprising instructions to:
based on the natural language input, provide a database,
wherein the output includes the database;
based on the input associated with the natural language input, create a property in the database;
receive a second natural language input describing a second input and a second output,
wherein the second output includes the property in the database; and
establish a second connection between the second input and the property in the database, wherein the second connection automatically updates the property in the database based on the second input.

18. The system of claim 14, comprising instructions to:
based on the natural language input, provide a database,
wherein the output includes the database,
wherein the database includes multiple properties and multiple records,
wherein a record among the multiple records includes a value associated with a property among the multiple properties; and
provide a view associated with the database without being prompted to provide the view by the natural language input,
wherein the view is associated with a particular property among the multiple properties in the database,
wherein the particular property is configured to assume multiple values, and
wherein the view shows the multiple values and a particular record among the multiple records associated with a particular value among the multiple values.

19. The system of claim 14, comprising instructions to:
obtain an indication of a list of steps to perform to satisfy the natural language input; and
provide the list of steps to the user.

20. The system of claim 14, comprising instructions to:
based on the natural language input, provide a database,
wherein the output includes the database,
wherein the database includes multiple properties;
provide the multiple properties to the user and a user interface enabling the user to modify the multiple properties;
receive a user input indicating whether to modify a property among the multiple properties; and
based on the user input in the multiple properties, create the database.
